(19) United States
(12) Patent Application Publication
(10) Pub. No.: US 2024/0328056 A1
(43) Pub. Date: Oct. 3, 2024

(54) INTERFACE AND LAUNDRY TREATING APPARATUS HAVING THE SAME

(71) Applicant: LG ELECTRONICS INC., Seoul (KR)

(72) Inventors: Dami CHOE, Seoul (KR); Eunsoo JUNG, Seoul (KR); Sangin CHUNG, Seoul (KR)

(73) Assignee: LG ELECTRONICS INC., Seoul (KR)

(21) Appl. No.: 18/575,575

(22) PCT Filed: Jun. 30, 2022
(86) PCT No.: PCT/KR2022/009388

§ 371 Date: Dec. 29, 2023

(30) Foreign Application Priority Data
Jun. 30, 2021 (KR) 10-2021-0085833

(51) Int. Cl. D06F 34/32; D06F 23/02; D06F 34/04; D06F 34/30; D06F 58/02; D06F 105/58

(52) U.S. Cl. CPC D06F 34/32; D06F 23/02; D06F 34/04; D06F 34/30; D06F 58/02; D06F 2105/58

(57) ABSTRACT

A laundry treating apparatus includes a cabinet, a drum provided inside the cabinet for accommodating laundry, a manipulation portion coupled to the cabinet for receiving a command for selecting or changing a course or an option for rotating the drum, a communicator provided inside the cabinet for receiving an external signal, a controller for inspecting the external signal or an internal state of the cabinet to generate notification information and a display portion for displaying the notification information to an outside.

### CROSS-REFERENCE TO RELATED APPLICATIONS

This application is a National Phase application under 35 U.S.C. 371 of International Application No. PCT/KR2022/009388, filed on Jun. 30, 2022, which claims the benefit of Korean Application No. 10-2021-0085833, filed on Jun. 30, 2021, the contents of which are incorporated by reference herein in their entirety.

### TECHNICAL FIELD

This application relates to an interface and a laundry treating apparatus having an interface.

### DESCRIPTION OF RELATED ART

An input/output device (an interface) for a user to input a control command to an electronic device is essential in the electronic device including a laundry treating apparatus capable of washing, drying, and washing and drying laundry (a common name of an object to be washed or an object to be dried).

The conventional interfaces were designed such that a display portion that displays a control command that a user may select, a search interface that allows the user to search for the control command displayed on the display portion, a selection portion that allows the user to select the control command displayed on the display portion, and input means that requests execution of the control command selected by the user are located in spaces separated from each other (KR 10-2014-0023986).

That is, in the conventional interface, a display (an LCD, an LED panel, and the like) on which the control command is displayed, a knob or a button that may search for the control command by allowing a control command executable by the corresponding electronic device to be displayed on the display, a button that inputs a control command to select the control command displayed on the display, a button that inputs a control command to request execution of the selected control command, and the like are located in spaces separated from each other. Such an arrangement was a factor determining a design of the interface (e.g., a design of the control panel) located on a front face of the electronic device such as the laundry treating apparatus.

In the conventional interface of the above structure, because the devices including the display had to be dispersedly arranged along a width direction of the electronic device or distributed along a height direction of the electronic device, a great space was required for installation of the interface.

The conventional laundry treating apparatus has a problem in that there is no guide on how to indicate notification information to a user when the notification information is generated. Thus, there is a problem of causing confusion to the user by displaying all of the notification information when the plurality of notification information is generated.

In addition, the conventional laundry treating apparatus displays notification information without changes, and there is a problem in that the user is capable of recognizing a weight of the notification information only when the user reads all the notification information.

In addition, the conventional laundry treating apparatus has a problem in that, when a plurality of notification information is generated, the notification information is displayed only at an arbitrary point in time or at a specific point in time, and thus it is not possible to efficiently display the notification information on one liquid crystal.

### SUMMARY OF THE DISCLOSURE

### Technical Problem

An object of the present disclosure is to provide a laundry treating apparatus for determining a time point of indicating notification information and distributing the notification information when the notification information is generated.

An object of the present disclosure is to provide a laundry treating apparatus for determining only specific notification information by setting priorities when the plural notification information is generated.

An object of the present disclosure is to provide a laundry treating apparatus for determining a weight of notification information and differently setting a method of indicating the notification information when the plural notification information is generated.

### Technical Solution

To achieve the object of the present disclosure, the present disclosure provides a laundry treating apparatus including a controller configured to inspect the external signal or an internal state of the cabinet to generate notification information, and a display portion configured to display the notification information to an outside.

The display portion may be controlled to display the notification information at any one of a booting time point of supplying power to the display portion, a selection time point of a course or an option for inputting the manipulation portion, an execution time point of executing the course or the option, and a completion time point of completing the course or the option.

The notification information may include condition information indicating that a condition required to execute the course or the option is insufficient, and the display portion may display the condition information at the booting time point or the selection time point.

The notification information may include recommendation information for recommending a specific course or option to a user, and the display portion may display the recommendation information at the booting time point or the selection time point.

The external signal may include one or more of weather, humidity, or temperature in an area in which the cabinet is located, and the controller may generate the recommendation information based on the external signal.

The controller may include a storage configured to store a usage history of the course or the option, and the controller may generate the recommendation information based on the usage history.

The controller may include a storage configured to store a usage history of the course or the option, the notification information may include arrangement information for preventing a course or an option without a usage history during a specific number or a specific period from being displayed on the display portion, and the display portion may display the arrangement information at the booting time point or the selection time point.

The notification information may include action information indicating a state in which the course or the option is not capable of being continued or the course or the option is not capable of being executed, and the display portion may display the action information at the execution time point.

The notification information may include recommendation information for recommending ventilation of the drum, and the display portion may display the recommendation information at the completion time point.

The notification information may include correction information for inducing the user to correct a method using the course or the option, and the display portion may display the correction information at the completion time point.

To achieve the object of the present disclosure, the present disclosure provides a laundry treating apparatus including a controller configured to inspect the external signal or an internal state of the cabinet to generate notification information, and a display portion configured to display the notification information to an outside.

The display portion may display the notification information without change when the notification information is singular, and the display portion may preferentially display one notification information when the notification information is plural.

The controller may determine priorities when the notification information is plural, and the display portion may display notification information related to a top priority among the plurality of notification information.

When the notification information related to the top priority is still plural, the display portion may sequentially display the notification information.

The display portion may first display one notification information among the plurality of notification information.

The display portion may display another notification information when the manipulation portion is input.

The display portion may alternately display the plurality of notification information.

When the notification information related to the top priority is still plural, the controller may integrate the plurality of notification information into one notification information.

The display portion may be set to block display of the three or more of the notification information.

The display portion may display two notification information among three notification information when the notification information related to the top priority is three or more.

The display portion may sequentially display the two or more notification information or may display the two or more notification information on one screen.

The controller may transmit the notification information to an outside through the communication module when the notification information is not displayed on the display portion.

To achieve the object of the present disclosure, the present disclosure provides a laundry treating apparatus including a controller configured to inspect the external signal or an internal state of the cabinet to generate notification information, and a display portion configured to display the notification information to an outside.

The display portion may display first notification information related to an internal state of the cabinet among the notification information longer or larger than second notification information related to the external signal.

When a reference time elapses, the display portion may remove display of the second notification information.

The display portion may display the second notification information on a partial screen or as a pop-up.

The display portion may display the first notification information on an entire screen or may display only the first notification information.

The display portion may display the first notification information until the manipulation portion is input.

The first notification information may include action information indicating a state in which the course or the option is not capable of being continued or the course or the option is not capable of being executed, and the display portion may display the action information until the manipulation portion is input.

The first notification information may include condition information indicating that a condition required to execute the course or the option is insufficient, and the display portion may remove display of the condition information when a specific time elapses.

The first notification information may include recommendation information for recommending a specific course or option to a user, and the display portion may remove display of the recommendation information when a specific time elapses.

The controller may include a storage configured to store a usage history of the course or the option, the first notification information may include arrangement information for preventing a course or an option without a usage history during a specific number or a specific period from being displayed on the display portion, and when a specific time elapses, the display portion may remove display of the arrangement information.

The first notification information may include recommendation information for recommending ventilation of the drum.

When a specific time elapses, the display portion may remove display of the recommendation information.

The display portion may further include a speaker for generating sound to an outside, and the speaker may generate sound when the first notification information is generated.

### Advantageous Effects

According to the present disclosure, when notification information is generated, a time of indicating notification information may be determined and the notification information may be distributed.

According to the present disclosure, when plural notification information is generated, priorities may be determined and only specific notification information may be selected.

According to the present disclosure, when plural notification information is generated, a weight of the notification information may be determined, and a method for indicating the notification information may be differently set.

Further scope of applicability of the invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 shows a home appliance system and an online system in which laundry treating apparatuses of the present disclosure are arranged.

FIG. 2 shows an embodiment of an internal structure of a laundry washing apparatus and a mini apparatus.

FIG. 3 shows a structure of a laundry dry apparatus among laundry treating apparatuses of the present disclosure.

FIG. 4 shows a detailed structure of a water collecting portion, a heat exchanger, a washer, and the like.

FIG. 5 shows an embodiment of an internal structure of a laundry dry apparatus of the present disclosure.

FIG. 6 shows a structure in which, when the laundry treating apparatus includes the laundry washing apparatus, the laundry dry apparatus, and the auxiliary apparatus, the apparatuses may be in communication with each other.

FIG. 7 shows an embodiment of a control panel P that may be applied to a laundry treating apparatus of the present disclosure.

FIG. 8 shows a structure in which a control panel is coupled to a front panel.

FIG. 9 shows an internal structure of a control panel.

FIG. 10 shows a structure of an encoder.

FIG. 11 shows a structure of manipulation portion and a display portion.

FIG. 12 shows an embodiment of utilization of the control panel.

FIG. 13 shows a notification point when a notification is generated in a laundry treating apparatus according to the present disclosure.

(a) to (c) of FIG. 14 shows an embodiment in which booting information is displayed on the display portion P8 at the execution time point.

FIG. 15 shows a type and a reference of notification information displayed at a booting time point or a selection time point in a laundry dry apparatus.

FIG. 16 shows a type and a reference of notification information displayed at an execution time point.

FIG. 17 shows a type and a reference of notification information to be displayed at an execution time point in the laundry dry apparatus 20 shown in FIG. 16.

FIG. 18 shows an embodiment in which the execution information is displayed on the display portion P8.

(a) and (b) of FIG. 19 show the case in which a user does not take an action even if action information is generated.

FIG. 20 shows a type and a reference of notification information to be displayed at a completion time point.

FIG. 21 shows a type and a reference of notification information to be displayed at a completion time point in the laundry dry apparatus 20.

(a)-(c) of FIG. 22 show an embodiment in which a plurality of notification information is generated and is display on the display portion P8 according to the present disclosure.

FIG. 23 shows a control method of displaying notification information by a laundry treating apparatus according to the present disclosure.

FIG. 24 shows a control method of determining and guiding priorities when there is a plurality of notifications.

FIG. 25 shows a control method in which a guiding method is changed according to importance of notification.

### DETAILED DESCRIPTION OF THE EMBODIMENTS

Hereinafter, embodiments disclosed in the present specification will be described in detail with reference to the accompanying drawings. In the present specification, even in different embodiments, the same and similar reference numerals are assigned to the same and similar components, and the description thereof is replaced with the first description. As used herein, the singular expression includes the plural expression unless the context clearly dictates otherwise. In addition, in describing the embodiments disclosed herein, when it is determined that a detailed description of a related known technology may obscure the gist of the embodiments disclosed herein, a detailed description thereof will be omitted. In addition, the accompanying drawings are only for easy understanding of the embodiments disclosed in the present specification, and it should be noted that the technical idea disclosed in the present specification is not to be construed as being limited by the accompanying drawings.

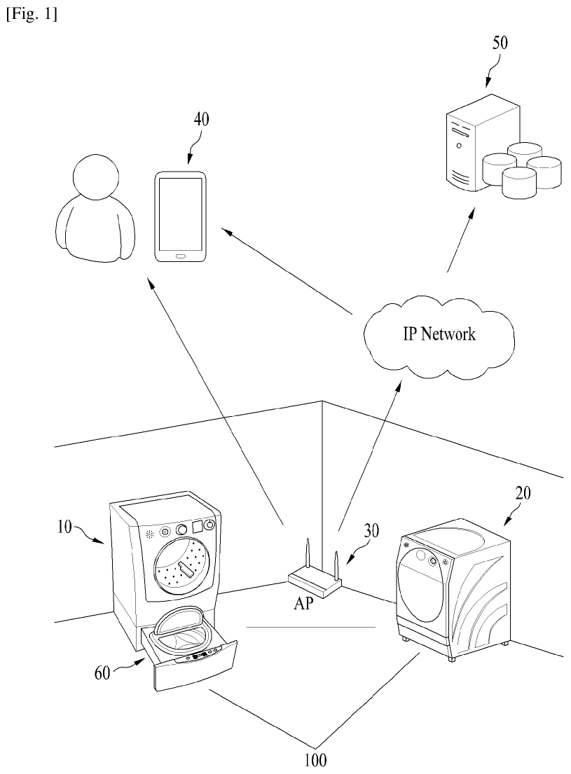

FIG. 1 shows a home appliance system and an online system in which a laundry treating apparatus of the present disclosure is disposed.

The laundry treating apparatus of the present disclosure may include a laundry washing apparatus 10 that performs an arbitrary washing course or washing option that performs a washing cycle for removing foreign substances from laundry using water and detergent, and a mini apparatus 60 that is disposed near or beneath the laundry washing apparatus and performs the arbitrary washing course or washing option that performs the washing cycle for removing the foreign substances from the laundry using the water and the detergent.

The laundry washing apparatus 10 may be of a front load type in which the laundry is put into the laundry washing apparatus 10 from a front face thereof, and the mini apparatus 60 may be of a top load type in which the laundry is put into the mini apparatus 60 from a top face thereof. As shown, the mini apparatus 60 may be disposed beneath the laundry washing apparatus 10 to increase a vertical level of a laundry inlet of the laundry washing apparatus 10. In this case, the mini apparatus 60 may be of a drawer type of being extended frontwards such that a laundry inlet thereof into which the laundry is put is exposed.

In addition, the mini apparatus 60 may be disposed on top of the laundry washing apparatus 10. Accordingly, a user may easily access the mini apparatus 60.

In one example, the laundry treating apparatus of the present disclosure may include a laundry dry apparatus 20 that performs an arbitrary drying course or drying option that dries the laundry containing moisture after the washing is completed in the laundry washing apparatus 10 or the mini apparatus 60.

The user may arrange the laundry washing apparatus 10 and the laundry dry apparatus 20 among the laundry treating apparatus of the present disclosure together in the room, and may include all of the components of the laundry treating apparatus by additionally including the mini apparatus 60.

Accordingly, the mini apparatus 60 may wash laundry that has a relatively small volume and is frequently washed, such as underwear and baby clothes. In addition, the laundry washing apparatus 10 may wash laundry that has a large volume and is infrequently washed, such as jeans and quilts.

In one example, at least one of the laundry washing apparatus 10, the laundry dry apparatus 20, and the mini apparatus 60 may access an Internet network via a router (AP) 30. At least one of the laundry washing apparatus 10, the laundry dry apparatus 20, and the mini apparatus 60 may have a communication module to connect to the router, and a server 50 provided by a producer who produced the laundry treating apparatus may recognize the laundry washing apparatus 10, the laundry dry apparatus 20, and the mini apparatus 60 via port information of the router 30 and register and control the laundry washing apparatus 10, the laundry dry apparatus 20, and the mini apparatus 60.

When the user has an external terminal 40 equipped with a communication module, such as a smartphone, the user may access the server 50 via the Internet network with the external terminal 40 to control at least one of the laundry washing apparatus 10, the laundry dry apparatus 20, and the mini apparatus 60.

In addition, the user may register at least one of the laundry washing apparatus 10, the laundry dry apparatus 20, and the mini apparatus 60 to the server 50 via the external terminal 40.

In addition, when there is notification information or there is an update of the course or the option for at least one of the laundry washing apparatus 10, the laundry dry apparatus 20, and the mini apparatus 60, the server 50 may notify the user with the external terminal 40.

In one example, the laundry washing apparatus 10, the laundry dry apparatus 20, and the mini apparatus 60 may be configured to be in communication with each other.

One of the laundry washing apparatus 10, the laundry dry apparatus 20, and the mini apparatus 60 may be configured to be in communication with the other two via the router 30 and the server 50. To this end, each of the laundry washing apparatus 10, the laundry dry apparatus 20, and the mini apparatus 60 may include the communication module, such as Wi-Fi.

In addition, the laundry washing apparatus 10, the laundry dry apparatus 20, and the mini apparatus 60 may be configured to be in communication with each other without the server 50. For example, the laundry washing apparatus 10, the laundry dry apparatus 20, and the mini apparatus 60 may be configured to be in communication with each other via a Bluetooth communication module.

The laundry washing apparatus 10, the laundry dry apparatus 20, and the mini apparatus 60 may be configured to be in communication with each other to share the states thereof with each other and to display each other's states.

For example, the user may identify the states of the laundry dry apparatus 20 and the mini apparatus 60 via the laundry washing apparatus 10. Therefore, even when the laundry dry apparatus 20 and the mini apparatus 60 are disposed to be spaced apart from the laundry washing apparatus 10 or are disposed at positions where the laundry dry apparatus 20 and the mini apparatus 60 are not visible when the user looks at the laundry washing apparatus 10, the user may display the states of the laundry dry apparatus 20 and the mini apparatus 60 via the laundry washing apparatus 10.

The laundry washing apparatus 10, the laundry dry apparatus 20, and the mini apparatus 60 may be configured to share names of a course or option thereof, a selected state of the course or option thereof, a executed state of the course or option thereof, a completion state of the course or option thereof, and an error or notification state thereof with each other or display each other's names and states of the courses or options and error or notification states.

In addition, one of the laundry washing apparatus 10, the laundry dry apparatus 20, and the mini apparatus 60 may be configured to manipulate the other two with a manipulation portion thereof for receiving a command.

The laundry washing apparatus 10, the laundry dry apparatus 20, and the mini apparatus 60 may transmit and receive control commands to and from each other via the respective communication modules thereof or the server 50.

Accordingly, even when the laundry washing apparatus 10, the laundry dry apparatus 20, and the mini apparatus 60 are spaced apart from each other, the user may control another device with one device, thereby improving convenience.

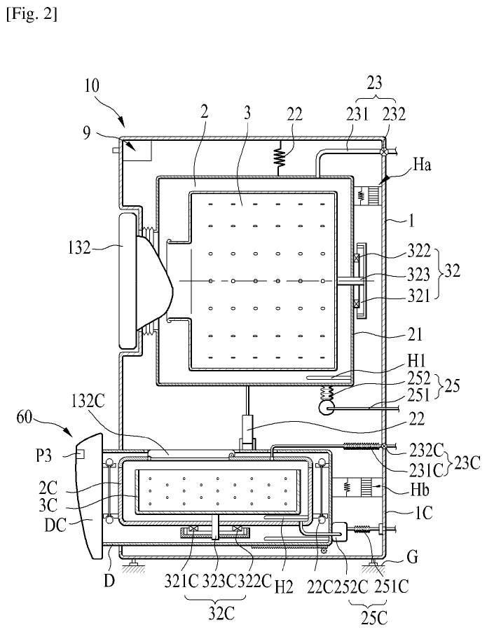

FIG. 2 shows an embodiment of internal structures of the laundry washing apparatus 10 and the mini apparatus 20.

Unlike the drawing, the laundry washing apparatus 10 and the mini apparatus 60 may be independently constructed to be separated from each other.

The laundry washing apparatus 10 may include a cabinet 1 that forms an appearance of the laundry washing apparatus, a tub 2 that is accommodated in the cabinet 1 and stores water therein, a drum 3 that is rotatably disposed in the tub 2 and stores water therein, a driver 32 that is coupled to the tub 2 to rotate the drum 3, a water supply 23 that is constructed to supply water to the tub 2, and a drainage 25 constructed to drain water of the tub 2.

Each of the tub 2 and the drum 3 may have the laundry inlet for putting the laundry into the laundry washing apparatus in a front face thereof, and the cabinet 1 may further include a door 132 for opening and closing the laundry inlet.

The driver 32 may include a stator 321 coupled to a rear face of the tub 2, a rotor 322 rotated by the stator 321, and a rotation shaft 323 coupled to the rotor 322 to rotate the drum 3.

The water supply 23 may include a water supply pipe 231 that allows an external water supply source and the tub 2 to be in communication with each other, and a water supply valve 232 that opens and closes the water supply pipe 231.

In one example, the water supply 23 may further include a detergent box that is able to be extended forwardly of the cabinet 1 and is constructed to put detergent into the tub 2, and the water supply pipe 231 may be in communication with the detergent box.

The drainage 25 may include a drain pipe 251 disposed below the tub 2, and a drain pump 252 coupled to the drain pipe 252 to provide power for discharging water.

The laundry washing apparatus 10 may further include a support 22 that supports the tub 2 to the cabinet 1, and a heater H1 that heats water inside the tub 2.

In addition, the laundry washing apparatus 10 may further include a hot air supply Ha constructed to supply hot air to the tub 2.

In one example, the laundry washing apparatus 10 may include a control panel P or a washing controller that receives a command for displaying or controlling the state of the laundry washing apparatus 10. The control panel P may be disposed coupled to the cabinet 1.

In addition, the control panel P may operate at least one of the driver 32, the water supply valve 232, the drain pump 252, the heater H1, and the hot air supply Ha to perform the arbitrary washing course and washing option for removing the foreign substances from the laundry. The washing course and the washing option may be composed of a series of control methods capable of performing all of a washing cycle, a rinsing cycle, and a dehydration cycle.

The mini apparatus 60 may include a mini cabinet 1C that forms an appearance of the mini cabinet, a mini tub 2C that is accommodated in the mini cabinet 1C and stores water therein, a mini drum 3C that is rotatably disposed in the mini tub 2C and stores water therein, a mini driver 32C that is coupled to the mini tub 2C to rotate the mini drum 3C, a mini water supply 23C constructed to supply water to the mini tub 2C, and a mini drainage 25C, constructed to drain water of the mini tub 2C.

The mini cabinet 1C may be disposed beneath the cabinet 1 to support the cabinet 1. It is not excluded that the mini cabinet is placed on top of the cabinet 1.

The mini cabinet may be formed integrally with the cabinet 1.

Each of the mini tub 2C and the mini drum 3C may have the laundry inlet for putting the laundry into the mini apparatus in a top face thereof, and the mini laundry cabinet 1C may further include a mini door 132C for opening and closing the laundry inlet.

The mini driver 32C may include a mini stator 321C coupled to a bottom face of the mini tub 2C, a mini rotor 322C rotated by the mini stator 321C, and a mini rotation shaft 323C coupled to the mini rotor 322C to rotate the mini drum 3C.

The mini water supply 23C may include a mini water supply pipe 231C that allows the external water source and the mini tub 2C to be in communication with each other, and a mini water supply valve 232C that opens and closes the mini water supply pipe 231C.

In one example, the mini water supply 23C may further include a mini detergent box that is able to be extended forwardly of the cabinet 1 and is constructed to put the detergent into the mini tub 2C, and the mini water supply pipe 231C may be in communication with the detergent box.

The mini drainage 25C may include a mini drain pipe 251C disposed below the mini tub 2C, and a mini drain pump 252C coupled to the mini drain pipe 252C to provide power for discharging water.

The mini apparatus 60 may further include a mini support 22C that supports the mini tub 2C to the mini cabinet 1C, and a mini heater H2 that heats water inside the mini tub 2C.

In addition, the mini apparatus 60 may further include a hot air supply HaC constructed to supply hot air to the mini tub 2C.

In one example, the mini apparatus 60 may include a mini control panel PC or a mini controller that receives a command for displaying or controlling the state of the mini apparatus 60. The mini control panel PC may be disposed coupled to the mini cabinet 1C.

In addition, the mini control panel PC may operate at least one of the mini driver 32C, the mini water supply valve 232C, the mini drain pump 252C, the mini heater H2, and the mini hot air supply HaC to perform the arbitrary washing course and washing option for removing the foreign substances from the laundry. The washing course and the washing option may be composed of a series of control methods capable of performing all of the washing cycle, the rinsing cycle, and the dehydration cycle.

The mini apparatus 60 may further include a drawer D that is able to be extended forwardly of the mini cabinet 1c and accommodates the mini tub 2c therein. The drawer D may include a front cover DC at a front face thereof to open and close an entrance through which the drawer D is extended from the mini cabinet 1C.

The mini control panel PC may be disposed on the front cover DC.

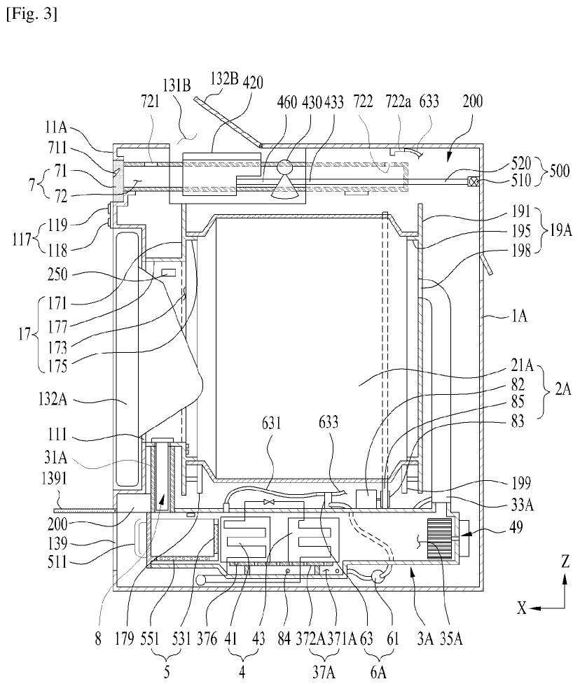

FIG. 3 shows a structure of the laundry dry apparatus 30 of the laundry treating apparatus of the present disclosure.

The laundry dry apparatus 20 may include a drying cabinet 1A, a drying drum 2A that is rotatably disposed inside the drying cabinet to provide a space for storing the laundry, a circulation flow path 3A that forms a flow path for re-supplying air discharged from the drying drum 2 to the drying drum 2A, and a heat exchanger 4 that dehumidifies and heats air introduced into the circulation flow path 3A and then re-supplies dehumidified and heated air to the drying drum 2A.

When the drying drum 2A is formed as a cylindrical drum body 21 with open front face and rear face, a first support 17A that rotatably supports the front face of the drum 2 and a second support 19A that rotatably supports the rear face of the drum 2 may be disposed inside the cabinet 1A.

The first support 17A may include a first fixed body 171 fixed inside the drying cabinet 1A, a drum laundry inlet 173 defined to extend through the first fixed body to allow the laundry inlet 111 and an interior of the drum body 21A to be in communication with each other, and a first support body 175 disposed on the first fixed body 171 and inserted into a front face (e.g., a first open face) of the drum body 21.

The first fixed body 171 may be in any shape as long as the drum laundry inlet 173 and the first support body 175 are able to be disposed. The first support body 175 may be formed in a pipe shape protruding from the first fixed body 171 toward the drying drum body 21A. A diameter of the first support body 175 may be larger than a diameter of the drum laundry inlet 173, and may be smaller than a diameter of a front face of the drying drum body 21A. In this case, the drum laundry inlet 173 will be located inside the space defined by the first support body 175.

The first support 17 may further include a connection body 177 that connects the laundry inlet 111 and the drum laundry inlet 173 to each other. The connection body 177 may be formed in a pipe shape extending from the drum laundry inlet 173 toward the laundry inlet 111. The connection body 177 may have an air outlet 178 in communication with the circulation flow path 3A.

The air outlet 178, as a passage that allows air inside the drying drum body 21A to flow to the circulation flow path 3, may be defined as a through-hole defined to extend through the connection body 177.

The second support 19A may include a second fixed body 191 fixed inside the cabinet 1A, and a second support body 195 disposed on the second fixed body 191 and inserted into a rear face (a second open face) of the drum body 21. The second support 19 includes an air inlet 198 defined to extend through the second fixed body 191 to allow an interior of the drum body 21 and an interior of the cabinet 1A to communicate with each other. In this case, a duct 3A may be constructed to connect the air outlet 178 and the air inlet 198 to each other.

The cylindrical drum body 21 with an empty interior may be rotated by various types of drying drivers. A case in which the drying driver includes a motor 82 fixed inside the drying cabinet 1A, a pulley 85 rotated by the motor, and a belt 83 that connects a circumferential surface of the pulley 85 and a circumferential surface of the drum body 21 to each other is shown as an example.

In one example, the drying driver may be disposed on a rear face of the drying drum 2A to directly rotate the drum 2A. A rotation shaft of the drying driver 28 may be directly coupled to the drum 2A to rotate the drying drum 2A.

In this case, the second support 19A may support the drying driver to be located on a rear face or at a center of the drying drum 2A.

In one example, a separate reducer 28a may be disposed between the drying driver 28A and the drying drum 2. In this case, a rotation shaft from the reducer 28a may be directly coupled to a center of the rear face of the drum 2, and the reducer 28a may be coupled to and supported by the second support 19.

In this regard, the drying driver 28A may freely change a rotation speed and a rotation direction of the drum 2A.

The first support 17A may have a first roller 179 that rotatably supports the circumferential surface of the drum body 21A, and the second support 19 may have a second roller 199 that rotatably supports the circumferential surface of the drum body.

The circulation flow path 3A may include a duct in communication with the drum 2. The duct 3A may be in communication with the drying drum 2A, so that it may be considered that the duct 3A forms a circulation flow path in which air discharged from the drying drum passes the heat exchanger 4 and is re-introduced into the drum 2A.

The duct 3A may include an exhaust duct 31A connected to the air outlet 178, a supply duct 33A connected to the air inlet 198, and a connection duct 35A that connects the exhaust duct and the supply duct to each other.

The heat exchanger 4 may be formed as various apparatuses, as long as the dehumidification and the heating of air introduced into the duct 3A may be sequentially performed. For example, the heat exchanger 4 may be formed as a heat pump system.

The heat exchanger 4 may include a fan 49 that allows air to flow along the duct 3A, a first heat exchanger (e.g., a heat absorber) 41 that removes moisture from air introduced into the duct 3A, and a second heat exchanger (e.g., a heater) 43 that is disposed inside the duct 3A to heat air that has passed through the first heat exchanger 41.

The heat absorber 41 may be formed as an evaporator that absorbs heat, and the heater 43 may be formed as a condenser that emits heat.

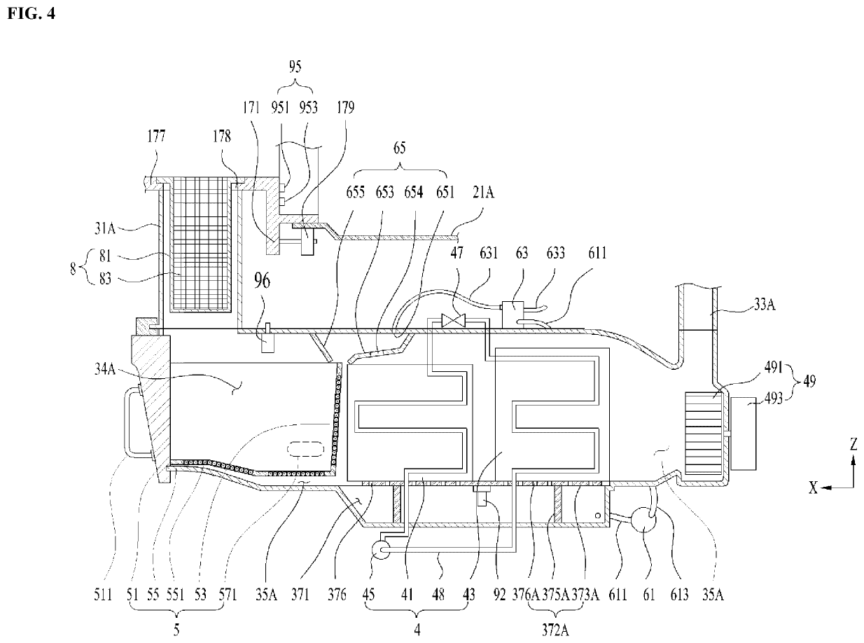

The fan 49 may include an impeller 491 disposed inside the duct 3A, and an impeller motor 493 that rotates the impeller 491 (see FIG. 4). The impeller 491 may be disposed in any of the exhaust duct 31A, the connection duct 35A, and the supply duct 33A. The impeller 491 may be disposed in the supply duct 33A.

The heat absorber 41 is formed with multiple metal plates disposed along a width direction (e.g., a Y-axis direction) of the connection duct 35A or a height direction (e.g., a Z-axis direction) of the connection duct, and the heater 43 may be formed with multiple metal plates disposed along the width direction of the connection duct or the height direction of the connection duct. The heat absorber 41 and the heater 43 are sequentially arranged inside the connection duct 35A in a direction from the exhaust duct 31A toward the supply duct 33A, and are connected to each other via a refrigerant pipe 48 that forms a circulation flow path of a refrigerant.

The refrigerant moves along the refrigerant pipe 48 by a compressor 45 located outside the duct 3A, and the refrigerant pipe 48 has a pressure regulator 47 that adjusts a pressure of the refrigerant that has passed through the heater 43.

The heat absorber 41 is means for cooling air and evaporating the refrigerant by transferring the heat of air introduced into the exhaust duct 31A to the refrigerant. The heater 43 is means for heating air and condensing the refrigerant by transferring the heat of the refrigerant that has passed through the compressor 45 to air. In this case, the moisture contained in air will be collected on a bottom face of the connection duct 35A along a surface of the heat absorber 41 when passing through the heat absorber 41.

In order to collect water removed from air passing through the heat absorber 41, the laundry dry apparatus 20 has a water collecting portion.

The water collected in the water collecting portion may be collected in a water storage 7 and discharged all at once later. The water storage 7 may include a water storage tank 72 that is detachably disposed in the cabinet 1 to provide a space for storing water, and an inlet 722 defined to extend through the water storage tank 72 to introduce water discharged from a water storage supply pipe 633 into the water storage tank 72.

The water storage tank 72 may be formed as a tank in a form of a drawer extended from the cabinet 1. In this case, the front panel 11 of the cabinet must have a water storage mounting hole or tank hole 115 into which the water storage tank 72 is inserted. A water storage panel 71 is fixed to a front face of the water storage tank 72. The water storage panel 71 may be detachably coupled to the water storage mounting hole or tank hole 115 to form a portion of the front panel 11A.

The water storage panel 71 may further include a groove 711 into which a user's hand is inserted. In this case, the water storage panel 71 will also perform a function of a handle for extending or retracting the water storage tank 72 from or into the cabinet.

The inlet 722 may be defined to receive water discharged from a nozzle 722a fixed to the cabinet 1A. The nozzle 722a may be fixed to a top panel 13 of the cabinet so as to be positioned above the inlet 722 when the storage body 72 is inserted into the cabinet 1.

In the water storage 7 having the above structure, the user may discard water inside the water storage tank 72 by extending the water storage tank 72 from the cabinet 1 and then inverting or tilting the water storage tank 72 in a direction in which the inlet 722 is directed. A communication hole 721 defined to extend through a top face of the storage body 72 may be further defined such that water inside the water storage tank 72 is easily discharged through the inlet 722.

In one example, the heat exchanger 4 is constructed to condense the moisture in air circulating in the heat absorber 41. Therefore, even when the air circulates in the drum 2A, the moisture is removed by the heat absorber 41, so that the laundry inside the drum 2A may be continuously dried.

The moisture condensed in the heat absorber 41 may be first collected in the water collecting portion 37 and then collected secondary in the water storage 7. The water collecting portion 37 may be located inside the connection duct 35, and may be separately disposed in a space spaced apart from the connection duct 35.

FIG. 4 shows a detailed structure of the water collecting portion 37, the heat exchanger 4, and a washer 6.

The water collecting portion 37A may be formed as a water collecting body 371A fixed to a bottom face of the connection duct 35A and in communication with the interior of the connection duct. A heat exchanger support 372A may be further disposed inside the water collecting body 371A such that the heat absorber 41 and the heater 43 do not come into contact with water (e.g., condensed water) stored in the water collecting body 371A. The heat exchanger support 372A may include a support plate 373A in contact with the heat absorber 41 and the heater 43, a spacer 375A that maintains a gap between the support plate 373 and a bottom face of the water collecting body 371A, and a support plate through-hole 376A defined to extend through the support plate 373A.

The support plate through-hole 376A may be defined only in a space in which the heat absorber 41 is supported of the space provided by the support plate 373A, and may be defined in each of the space in which the heat absorber is supported and a space in which the heater is supported. When the support plate through-hole 376A is also defined in a bottom face of the heater 43, water flowed to the heater 43 along the support plate 373A may be discharged to the water collecting portion 371A (e.g., to prevent a decrease in heat transfer efficiency that occurs when the heater comes into contact water).

In order to minimize the foreign substances (e.g., lint and the like) discharged from the drying drum body 21A being stacked in the heat absorber 41 and the heater 43, the laundry dry apparatus 20 may further include filtration means for filtering air.

Second filtration means 8 may be formed as means for filtering air introduced into the exhaust duct 31A from the drying drum body 21A, and first filtration means 5 may be located between the second filtration means 8 and the heat absorber 41 and be formed as means for filtering air that has passed through the second filtration means. A diameter of a filtration hole defined in the first filtration means 5 may be set smaller than a diameter of a filtration hole defined in the second filtration means 8.

The second filtration means 8 may include a frame 81 that is detachably inserted into the exhaust duct 31A through the air outlet 178, and a filter (e.g., a fourth filter) 83 disposed in the frame to filter air.

The first filtration means 5 may be detachably disposed in the connection duct 35. In this case, the front panel 11 of the cabinet may have a filter mounting hole 113 from which the first filtration means 5 is withdrawn and a mounting hole door 114 that opens and closes the filter mounting hole, and the duct 3A may have a duct through-hole 34 (see FIG. 3) into which the first filtration means 5 is inserted. Accordingly, the user may remove the foreign substances remaining in the first filtration means 5 and wash the first filtration means after separating the first filtration means 5 from the laundry treating apparatus as needed.

The first filtration means 5 may include a filtration means body 51, 53, 57, and 58 inserted into the filter mounting hole 113 and the duct through-hole 34 and positioned between the second filtration means 8 and the heat absorber 41, and filters 531, 551, and 571 disposed in the filtration means body to filter fluid (e.g., air and water) flowing to the heat absorber 41 and the water collecting portion 371.

The filtration means body may be formed in various forms depending on a shape of a cross-section (a Y-Z plane and a X-Z plane) of the connection duct 35. FIG. 1 shows an example of a case in which the filtration means body is formed in a shape similar to a hexahedron.

In this case, the filtration means body may include a front face 51 formed in a shape capable of closing the duct through-hole 34, a rear face 53 positioned between the front face and the heat absorber 41, a bottom face 55 constructed to connect the front face and the rear face with each other, and a first side face 57 and a second side face 58 that form a left side face and a right side face of the filtration means body.

The front face 51 may have a lock 513 removably coupled to a lock fastening portion 16 disposed in the cabinet. The lock 513 may be formed as a bar rotatably coupled to the front face 51 of the filtration means body, and the lock fastening portion 16 may define a groove in which a free end of the bar is accommodated. Preferably, the locks 513 are respectively disposed on opposite sides of the front face 51, and the lock fastening portions 16 are respectively disposed on opposite sides of the filter mounting hole 113.

To facilitate insertion of the filtration means body into the connection duct 35 or removal of the filtration means from the connection duct 35, the front face 51 may further include a handle 511.

The rear face 53 and the bottom face 55 may respectively have a first filter 531 and a second filter 551 for filtering the fluid (e.g., air and water) introduced into the filtration means body. The rear face 53 has a rear face through-hole defined therein for allowing an interior of the filtration means body and the internal space of the duct 3A to be in communication with each other, and the first filter 531 is disposed in the rear face through-hole. The bottom face 55 has a bottom face through-hole for allowing the interior of the filtration means body and the internal space of the duct 3A to be in communication with each other, and the second filter 551 is disposed in the bottom face through-hole. Therefore, the first filter 531 is means for filtering the fluid (e.g., air and water) supplied to the heat absorber 41, and the second filter 551 is means for filtering the fluid supplied to the water collecting portion 371.

The first side face 57 and the second side face 58 may be constructed to connect the front face 51, the rear face 53, and the bottom face 55 to each other.

The first filtration means 5 having the above structure may be in communication with the exhaust duct 31 through the top face or the second side face 58 of the filtration means body. FIG. 1 shows a case in which the first filtration means 5 is connected to the exhaust duct 31 through a top face through-hole defined to extend through the top face of the filtration means body and a side face through-hole defined to extend through the second side face 58 as an example.

The first filter 531 may be inclined in an angle range from 90 degrees to 100 degrees toward a front face of the heat absorber 41 based on the bottom face 55 of the filtration means body. This is to allow the foreign substances remaining in the first filter to easily move to the bottom face 55 when water is injected into the first filter 531 via the washer 6 to be described later.

The second filter 551 may be inclined downward in an angle range from 10 to 20 degrees from the front face 51 toward the first filter 531 (e.g., the second filter may be inclined upward in an angle range from 10 to 20 degrees in a direction from a lower end of the first filter to the filter mounting hole). When the second filter 551 is inclined downward toward the first filter 531, because a connection point of the first filter 531 and the second filter 551 will be the lowest point in the space provided by the first filtration means, the foreign substances of the first filtration means 5 may be concentrated at the connection point of the first filter 531 and the second filter 551. When the foreign substances are concentrated at the connection point of the first filter 531 and the second filter 551, the user will be able to more easily remove the foreign substances inside the first filtration means 5.

However, when the foreign substances are concentrated at the connection point of the first filter 531 and the second filter 551, there may be a situation in which a long time is required for water sprayed via the washer 6 to be discharged to the water collecting portion 371. In order to solve such problem, a bypass hole for allowing the interior of the first filtration means 5 and the water collecting portion 371 to be in communication with each other, and a third filter 571 disposed in the bypass hole may be further disposed.

The bypass hole and the third filter 571 may be defined at a position higher than an uppermost end of the second filter 551 and lower than an uppermost end of the first filter 531. Therefore, the laundry treating apparatus may minimize a phenomenon in which water sprayed to the first filtration means 5 is not able to be recovered at the water collecting portion 371 by the foreign substances remaining in the first filtration means 5.

In one example, the laundry dry apparatus 20 may further include the washer 6 that washes the first filtration means 5 using water stored in the water collecting portion 371. That is, water stored in the water collecting portion 371 may be separately collected into the water storage 7 or may be selectively flowed to the washer 6.

The washer 6 may be formed as means for washing at least one of the first filter 531, the second filter 551, the third filter 571, and the heat absorbers 41 by spraying water stored in the water collecting portion 371 to the first filtration means 5. The washer 6 may include a spray 65 disposed in the duct 3A to supply water to the first filtration means 5, and a washing pump 61 that allows water stored in the water collecting portion 371 to flow to the spray 65.

The washing pump 61 may be connected to the water collecting portion 371 via a first connection pipe 611, and may be connected to the spray 65 via a second connection pipe 613. When the laundry treating apparatus is constructed to allow water of the water collecting portion 371 to flow to the spraying portion 65 and the water storage 7 with only one washing pump 61, the laundry dry apparatus 20 may further include flow path switching portion 63. In this case, the flow path switching portion 63 may be connected to the washing pump 61 via he second connection pipe 613, the spray 65 may be connected to the flow path switching portion 63 via a spray supply pipe 631, and the water storage 7 may be connected to the flow path switching portion 63 via the water storage supply pipe 633.

In this case, the water storage supply pipe 633 should connect the nozzle 722a and the flow path switching portion 63 to each other.

The flow path switching portion 63 includes a valve for controlling opening and closing of the spray supply pipe 631 and opening and closing of the water storage supply pipe 633. Therefore, the laundry dry apparatus 20 may control the valve disposed in the flow path switching portion 63 to supply water stored in the water collecting portion 371 to the spray 65 or to the water storage 7.

A case in which the spray 65 includes a duct through-hole 651 defined to extent through the connection duct 35 and to which the spray supply pipe 631 is connected, a first guide 653 that guides water supplied from the duct through-hole to the first filter 531, and a second guide 655 that guides at least a portion of water supplied through the first guide 653 to the front face of the heat absorber 41 is shown as an example. In this case, the second guide 655 may be disposed as means for allowing water to be supplied to the front face of the heat absorber 41 via the first filter 531. That is, the first filter 531 may be disposed between the first guide 653 and the second guide 655 when the first filtration means 5 is fixed to the connection duct 35, and the second guide 655 may be formed as an inclined face inclined downward toward the first filter 531 from a top face of the connection duct 35.

The first guide 653 may further include a guide through-hole 654. The guide through-hole 654, as a hole defined to extend through the first guide 653, may allow water introduced into the duct through-hole 651 to be supplied to a front area of the heat absorber 41 through the guide through-hole 654. The front area of the heat absorber means an area positioned at a side facing toward the first filter 531 based on a vertical line passing through a center of the heat absorber 41.

In one example, it is preferable that the laundry treating apparatus of the present disclosure includes water collecting portion water level sensing means 91 that measures a water level of the water collecting portion 371 and transmits the water level to the controller. When the water collecting portion water level sensing means 91 is disposed, the laundry treating apparatus may determine a time point of allowing water stored in the water collecting portion 371 to flow to the storage body 72. Therefore, water of the water collecting portion 371 may be prevented from flowing back into the connection duct 35.

The water collecting portion water level sensing means 91 may be formed as any device capable of sensing the water level inside the water collecting portion 371. FIG. 3 shows a sensor with multiple electrodes having different lengths (e.g., multiple electrodes electrically connected based on the water level) as an example.

The laundry dry apparatus 20 may have dryness sensing means to determine a time point to stop operation of the heat exchanger 4 by determining a dryness of the laundry. The dryness sensing means may be formed as at least one of an electrode sensor 95 constructed to be in contact with the laundry to measure an amount of moisture contained in the laundry, and a humidity sensor for measuring humidity of air introduced into the duct 3A from the drum 2.

The electrode sensor may include a first electrode 951 and a second electrode 953 that may be fixed to the first fixed body 171 and may be in contact with the laundry inside the drum body 21. As the dryness increases, the amount of moisture contained in the laundry will decrease (e.g., an electrical resistance of the laundry will increase), so that the laundry dry apparatus 20 may determine the dryness of the laundry by observing an electrical resistance measured when the two electrodes 951 and 953 are connected to each other via the laundry. In one example, as the dryness of the laundry increases, the amount of moisture contained in air introduced into the duct 3A will decrease, so that the laundry dry apparatus 20 may determine the dryness of the laundry by observing the humidity of air introduced into the duct 3A via the humidity sensor. In addition, the laundry dry apparatus 20 may further include temperature sensing means 96 for measuring a temperature of air introduced into the duct 3A. The temperature sensing means 96 may be fixed to the top face of the connection duct 35 and positioned between the first filter 531 and the second filter 551.

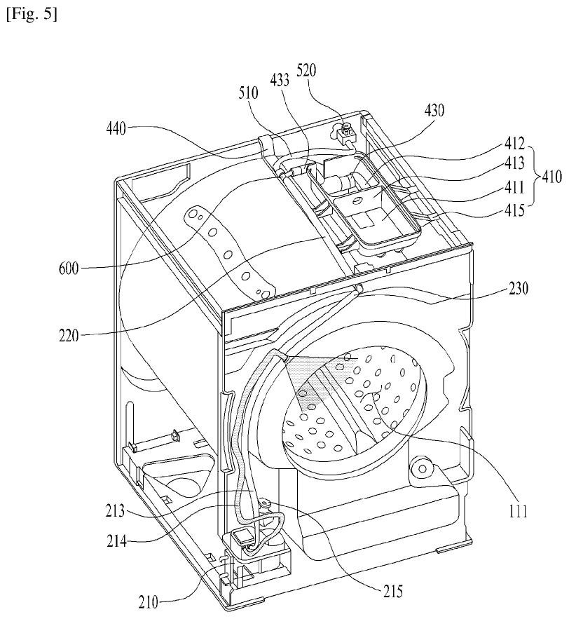

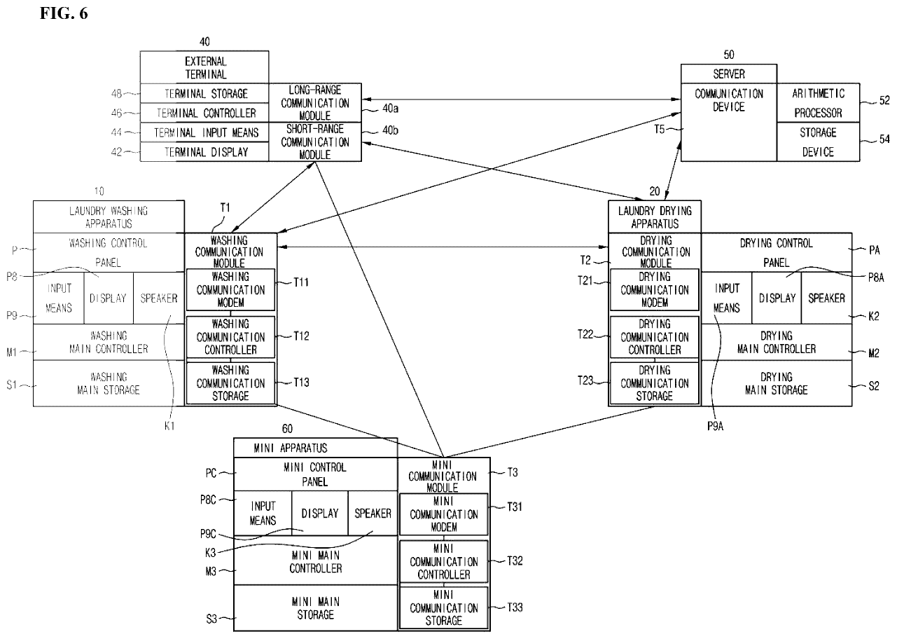

FIG. 5 shows an embodiment of an internal structure of the laundry dry apparatus 20 of the present disclosure.

The driver 28 may be directly fastened to a rear face of the drying drum 2A. The drying driver 28 may be disposed on the second support 19 to directly rotate the drying drum 2A.

The drying driver 28 may include a stator supported by the second support 19, a rotor rotated by the stator, and a rotation shaft.

The drying driver 28 may be separately coupled to a reducer 28A, and the reducer 28A may be coupled to a center (e.g., a rotation center) of a rear face of the drying drum 2A to rotate the drying drum 2A.

Accordingly, the reducer 28A may increase a torque while reducing an RPM of the rotation shaft.

The steam apparatus 200 may be disposed to be fixed to the front panel 11 or the first support supporting the drum 2 for space utilization. In addition, the steam apparatus 200 may be disposed adjacent to a corner of the cabinet 1.

The internal supply 400 may include a water tank 420 for storing water, a water pump 430 for supplying power for supplying the water stored in the water tank 420 to the steam apparatus 200, and a tank housing 410 that provides a space in which the water pump 430 and the water tank 420 are installed.

The tank housing 410 may be formed in a box shape with an open top face, and may extend along a front and rear direction of the cabinet 1 such that the water tank 420 may be disposed in a front portion of the cabinet 1 and the water pump 430 may be disposed in a rear portion of the cabinet 1.

The tank housing 410 may include a tank mounting portion 411 in which the water tank 420 is detachably mounted, and a pump mounting portion 412 in which the water pump 430 may be mounted. The tank mounting portion 411 and the pump mounting portion 412 may be formed in a recessed shape to prevent water leaking from the water tank 420 or the water pump 430 from leaking to the drying drum 2A or the like.

In addition, the tank housing 410 may further include a partition wall 413 partitioning the tank mounting portion 411 and the pump mounting portion 412 from each other. Accordingly, the water tank 420 may be easily mounted in and detached from the tank housing 410. The partition wall 413 may also serve to collect residual water in the tank mounting portion 411 or residual water in the pump mounting portion 412 such that the residual water does not flow to another place.

An extension pipe 416 for allowing the water tank 420 and the water pump 430 to be in communication with each other may be installed in the partition wall 413. A valve structure may be installed on the extension pipe 416 to prevent leakage of water even when the water tank 420 is removed from the tank mounting portion 411.

The extension pipe 416 may extend from the partition wall 413 toward the water pump 430 or toward the water tank 420.

In one example, the tank housing 410 may be formed such that the pump mounting portion 412 is disposed closer to the steam apparatus 200 than the tank mounting portion 411. Accordingly, a flow path from the water tank 420 to the steam apparatus 200 may become simplified.

The tank housing 410 may be formed such that the tank mounting portion 411 and the pump mounting portion 412 are arranged along a front and rear direction of the cabinet.

The water supply 300 may include a coupling portion capable of fixing the tank housing 410 to at least one of the support bar 440 and one side face of the cabinet.

A rotating drying drum 2A is disposed inside the drying cabinet 1. Accordingly, the components arranged inside the cabinet 1 need to be spaced apart from the drying drum 2A. Therefore, it is necessary to prevent the water supply 300 and the steam apparatus 200 from coming into contact with the drum 2. For example, a steam guide pipe 230 for supplying steam from the steam apparatus 200 to the drum 2, the direct water pipe 510 for supplying water to the steam apparatus 200, or the like needs to be blocked from coming into contact with the drying drum 2A.

It is necessary to support not only the water tank 420 and the water pump 430 but also a load of water accommodated in the water tank 420.

Therefore, the laundry treating apparatus of the present disclosure may include a support bar 440 for supporting the steam apparatus 200 and the water supply 300 to prevent the steam apparatus 200 and the water supply 300 from coming into contact with the drum, and supporting the steam apparatus 200 and the water supply 300 inside the drying cabinet.

The support bar 440 may be constructed to support at least a portion of the steam apparatus 200 or at least a portion of the water supply 300. In addition, the support bar 440 may fix or support the tank housing 410 to the drying cabinet.

The support bar 440 may be formed in a shape of a bar having both ends respectively coupled to the drying front panel 11 and the drying rear panel 12. Accordingly, the support bar 440 may support a load of the tank housing 410 as well as fix the drying front panel 11 and the drying rear panel 12. The support bar 440 may be spaced apart from the drying side panel 14 by a predetermined distance and coupled to the drying front panel 11 and the drying rear panel 12. In one example, the both ends of the support bar 440 may be coupled to the cabinet 1, but remaining portion thereof may be disposed at a lower position than an upper portion of the side face of the cabinet 1. Accordingly, the support bar 440 may be spaced apart from the top panel 13 to prevent interference with the top panel 13. In addition, a space capable of supporting some components of the water supply 300 and the steam apparatus 200 may be defined between the support bar 440 and the top panel 13.

An excessive extension of a width of the tank housing 410 may be prevented by the support bar 440.

In one example, the tank housing 410 may further include a mounting sensor capable of sensing mounting of the water tank 420 on an inner face thereof. The mounting sensor may be formed as a weight sensor, and may be configured to distinguish whether the weight is small or great.

The mounting sensor may be connected to the drying control panel PA to transmit information on whether the water tank 420 is mounted and an amount of water accommodated in the water tank 420.

The internal supply 400 may include a pump discharge pipe 433 for discharging water from the pump housing 430 to the steam apparatus 200.

The external supply 500 may include a direct water valve 520 seated on the second support 19A or the drying rear panel 12, and a direct water pipe 510 constructed to supply water from the direct water valve 520 to the steam apparatus 200.

The direct water pipe 510 may extend from the drying rear panel 12 to the steam apparatus 200, and the direct water valve 520 may be constructed to open and close the direct water pipe 510. The direct water pipe 510 may extend from the direct water valve 520 to the steam generator 210 across the support bar 440. In this regard, at least a portion of the direct water pipe 510 may be supported by the support bar 440 to prevent contact with the drying drum 2A.

The support bar 440 may be disposed between the direct water valve 520 and the water tank 430.

In addition, the direct water valve 520 may be seated on the drying rear panel 12 or the second support 19A to be exposed to the outside, and the direct water pipe 510 may extend from the direct water valve 520 toward the steam apparatus 200. Accordingly, the external supply 500 may supply water to the steam apparatus 200 in a direct water scheme from an external water supply source.

The steam apparatus 200 may receive water from each of the external supply 500 and the internal supply 400. However, when the steam apparatus 200 is constructed to receive water through respective pipes, a separate shape of the steam apparatus 200 must be manufactured, so that a flow path and a control method may become complicated.

To this end, the laundry treating apparatus of the present disclosure may further include a combining portion 600 for coupling the direct water pipe 510 with the pump discharge pipe 433. The combining portion 600 may be constructed such that both the water stored in the internal supply 400 and the water supplied in the direct water scheme from the external supply 500 are collected.

In addition, the combining portion 600 may be constructed to deliver the supplied water to the steam apparatus 200. The combining portion 600 may be formed as a three-way valve, or may be formed in a shape of a combining pipe in which three pipes are coupled to each other.

When the combining portion 600 is formed in the pipe shape, a check valve may be disposed in each of the external supply 500 and the internal supply 400 to prevent backflow. Specifically, a direct water check valve 511 for opening the direct water pipe 510 in one direction may be installed on the direct water pipe 510, and the pump discharge pipe 433 may have a discharge check valve 434 for opening the pump discharge pipe 433 in one direction.

In addition, the check valves may be disposed on the pump discharge pipe 433 and the direct water pipe 510, respectively. The external supply 500 may include an external check valve, and the internal supply 400 may include an internal check valve.

Accordingly, the water supplied to the direct water pipe 510 may be prevented from flowing back to the water pump 430, and the water supplied to the pump discharge pipe 433 may be prevented from flowing back to the direct water valve 510.

In one example, the combining portion 600 has a significant weight when formed as the valve or the combining pipe. In addition, when water passes through the combining portion 600, a considerable weight may be applied to the combining portion 600.

Accordingly, the combining portion 600 may be seated on the support bar 440.

The combining portion 600 and the support bar 400 may be coupled with each other using a separate fixing member to prevent the combining portion 600 from being separated from the support bar 400. Because the combining portion 600 is seated on the support bar 400, positions of the direct water pipe 510 and the pump discharge pipe 433 may also be stably fixed.

In one example, the steam apparatus 200 may include a water guide pipe 220 connected to the combining portion 600 to receive water from the water supply 300, a steam generator 210 that receives water from the water guide pipe 220 to generate steam, and a steam guide pipe 230 capable of guiding the steam generated by the steam generator 210 to the drying drum 2A or the duct 3A.

The steam generator 210 may be disposed below the drying drum 2A to stably receive water from the water supply 300 by gravity, and the generated steam may be stably moved to the drying drum 2A by a difference in density.

The steam guide pipe 230 may be constructed to be in communication with a gasket disposed on a front face of the drying drum 2A, or the first support. Accordingly, the steam guide pipe 230 may stably supply steam into the drying drum 2A without being in contact with the drying drum 2A.

In one example, the tank housing 410 may have a mounting sensor capable of sensing whether the water tank 420 is mounted. For example, the mounting sensor may be formed as a pressure sensor or the like.

In addition, a water level sensor capable of sensing a water level of the water tank 420 may be further disposed. For example, the water level sensor may be formed as a weight sensor. The mounted sensor or the water level sensor may also be controlled by the control panel 820, and may be configured to transmit a signal to the control panel 820.

In one example, the control panel P may indirectly identify the water level of the water tank 420 by temporarily driving the water pump 430 to sense a load applied to the water pump 430.

The water storage tank 72 may have a significantly larger volume than the water tank 430, and may be disposed to be spaced apart from the water tank 430 in order to prevent confusion of the user between the water storage tank 72 and the water tank 430.

The water tank 430 and the steam apparatus 200 may be disposed between the support bar 440 and one side face of the cabinet, and the water storage tank 72 may be disposed between the support bar 440 and the other side face of the cabinet.

Because the water tank 430 is coupled to the tank mounting portion 411, it may be seen that the tank mounting portion 411 is also disposed between the support bar 440 and one side face of the cabinet.

Consequently, the support bar 440 may be disposed between the water storage tank 72 and the steam generator 210, and may be disposed between the water storage tank 72 and the water tank 430.

FIG. 6 shows a structure in which, when the laundry treating apparatus includes the laundry washing apparatus 10, the laundry dry apparatus 20, and the auxiliary apparatus 60, the laundry washing apparatus 10, the laundry dry apparatus 20, and the auxiliary apparatus 60 may be in communication with each other.

The laundry washing apparatus 10 may include a washing control panel P configured to display information and to receive a command from the user.

The washing control panel P may include a display portion P8 capable of displaying the state of the laundry washing apparatus 10, an input means P9 capable of inputting the command to the laundry washing apparatus 10, and a washing speaker K1 capable of externally outputting a notification generated from the laundry washing apparatus 10. The laundry washing apparatus 10 may include a controller M1 that may perform the washing course and option including the driver, the water supply, the drainage, and the like of the laundry washing apparatus 10, and may include storage S1 that transmits the information to the controller M1 or stores a program to be used by the controller M1.

The input means P9 may be a concept including all components configured to receive the command of the user for the laundry washing apparatus 10, such as a manipulation portion P4, a power switch P46, an executing means P47, a setting portion P2, and the like to be described later.

In addition, the laundry washing apparatus 10 may include a communication module T1. The communication module T1 may include a communication modem T11 including means of communication such as Wi-Fi or Bluetooth, a communication controller T12 configured to control the communication modem, and communication storage T13 that may transmit the received information to the controller M1 or may store a program for controlling the communication controller T12 when power to the controller M1 is cut off.

The communication module T1 may be configured to continuously receive the power even in a state in which power supply to the control panel P of the laundry washing apparatus 10 is cut off, and may be configured to maintain a state in communication with the external terminal 40 and the server 50.

In addition, the communication module T1 may be configured to be directly paired with a drying communication module T2 and a mini communication module T31 to be described later to maintain the communication state.

In addition, when the communication module T1 receives a power command for supplying power to the control panel p, the power may be controlled to be supplied to the control panel P.

The laundry dry apparatus 20 may include a drying control panel PA configured to display information and to receive a command from the user.

The drying control panel PA may include a drying display portion P8A capable of displaying the state of the laundry dry apparatus 20, a drying input means P9A capable of inputting the command to the laundry dry apparatus 20, and a drying speaker K2 capable of externally outputting a notification generated from the laundry dry apparatus 20. The laundry dry apparatus 20 may include a drying controller M2 that may perform the drying course and option of operating the driver and the like, and may include drying storage S2 that transmits the information to the drying controller M1 or stores a program to be used by the drying controller M1.

The drying input means P9A may be a concept including all components configured to receive the command of the user for the laundry washing apparatus 10, such as the manipulation portion P4, the power switch P46, the executing means P47, the setting portion P2, and the like to be described later.

In addition, the laundry dry apparatus 20 may include a drying communication module T2. The drying communication module T2 may include a drying communication modem T21 including means of communication such as the Wi-Fi or the Bluetooth, a drying communication controller T22 configured to control the communication modem, and drying communication storage T23 that may transmit the received information to the drying controller M2 or may store a program for controlling the drying communication controller T22 when power to the drying controller M2 is cut off.

The drying communication module T2 may be configured to continuously receive the power even in a state in which power supply to the drying control panel PA of the laundry dry apparatus 20 is cut off, and may be configured to maintain a state in communication with the external terminal 40 and the server 50.

In addition, the drying communication module T2 may be configured to be directly paired with the communication module T1 and the mini communication module T31 to be described later to maintain the communication state.

In addition, when the drying communication module T2 receives a power command for supplying power to the drying control panel PA, the power may be controlled to be supplied to the drying control panel PA.

The mini apparatus 60 may include a mini control panel PC configured to display information and to receive a command from the user.

The mini control panel PC may include a mini display portion P8C capable of displaying the state of the mini apparatus 60, a mini input means P9C capable of inputting the command to the mini apparatus 60, and a mini speaker K3 capable of externally outputting a notification generated from the mini apparatus 60. The mini apparatus 60 may include a mini controller M3 that may perform the washing course and option of operating the driver, the water supply, the drainage, and the like of the mini apparatus 60, and may include mini storage S3 that transmits the information to the mini controller M3 or stores a program to be used by the mini controller M3.

The mini input means P9C may be a concept including all components configured to receive the command of the user for the laundry washing apparatus 10, such as the manipulation portion P4, the power switch P46, the executing means P47, the setting portion P2, and the like to be described later.

In addition, the mini apparatus 60 may include a mini communication module T3. The mini communication module T3 may include a mini communication modem T31 including means of communication such as the Wi-Fi or the Bluetooth, a mini communication controller T32 configured to control the mini communication modem, and mini communication storage T33 that may transmit the received information to the mini controller M3 or may store a program for controlling the mini communication controller T32 when power to the mini controller M3 is cut off.

The mini communication module T3 may be configured to continuously receive the power even in a state in which power supply to the mini control panel PC of the mini apparatus 60 is cut off, and may be configured to maintain a state in communication with the external terminal 40 and the server 50.

In addition, the mini communication module T3 may be configured to be directly paired with the communication module T1 and the drying communication module T2 to be described later to maintain the communication state.

In addition, when the mini communication module T3 receives a power command for supplying power to the mini control panel PC, the power may be controlled to be supplied to the mini control panel PC.

In one example, the external terminal 40 may include a short-range communication module 40b configured to be in direct communication with the laundry washing apparatus 10, the laundry dry apparatus 20, and the mini apparatus 60, and a long-range communication module 40a configured to be in communication with the server 50.

In addition, the external terminal 40 may further include a terminal display portion 42 for displaying the information received from the communication module, a terminal input means 44 that transmits the command to a home appliance such as the laundry washing apparatus 10 or to the server 50, and a terminal controller 46 for controlling the terminal display portion 42, the terminal input means 44, and the communication module. The external terminal 40 may further include terminal storage 48 to store the information received from the communication module or to store a program for controlling the terminal controller 46.

The server 50 may include a communication device 5 capable of being in communication with the external terminal 40, the laundry washing apparatus 10, the laundry dry apparatus 20, and the mini apparatus 60, an arithmetic processor 52 that calculates information received from or to be transmitted to the external terminal 40, the laundry washing apparatus 10, the laundry dry apparatus 20, and the mini apparatus 60, and a storage device 54 in which the information received from the external terminal 40, the laundry washing apparatus 10, the laundry dry apparatus 20, and the mini apparatus 60 may be stored or the arbitrary course or option that may operate the laundry washing apparatus 10, the laundry dry apparatus 20, and the mini apparatus 60 may be stored.

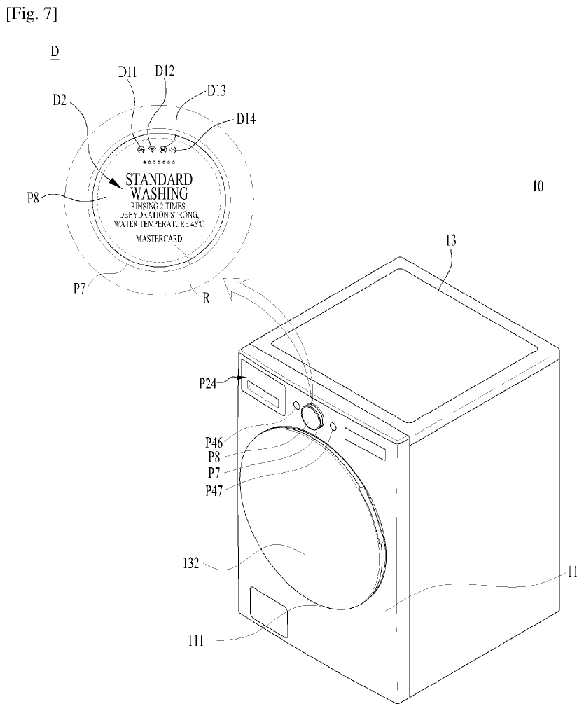

FIG. 7 shows an embodiment of the control panel P that may be applied to the laundry treating apparatus of the present disclosure.

Hereinafter, a description will be made based on the control panel P being disposed in the laundry washing apparatus 10, but the control panel P may be applied to the laundry washing apparatus 10 and the laundry dry apparatus 20 with the same structure and may also be applied to the mini apparatus 60.

In other words, the control panel P, the drying control panel PA, and the mini control panel PC may have the same structure.

The laundry washing apparatus 10 includes the cabinet 1 and the control panel P disposed on the cabinet 1.

The control panel P refers to a device that enables communication between the user and the laundry treating apparatus (e.g., including other electronic devices in addition to the laundry treating apparatus). The communication between the user and the laundry treating apparatus means a process in which the user inputs the control command to the laundry treating apparatus and a process in which the laundry treating apparatus transmits the information to the user.

The user may input, via the control panel P, at least one of a power command of supplying or cutting off the power of the laundry treating apparatus, a selection command of selecting the arbitrary course or option that treats the laundry, an execution command of performing the selected course or option, and a stop command of stopping the course or option being performed.

The treatment of the laundry may include the washing cycle of removing the foreign substances of the laundry via water and the detergent, or a drying cycle of drying water contained in the laundry.

The control panel P may display an operation state of the laundry treating apparatus or information of the course or option to the user.

For example, the control panel P may display a state in which at least one of the power command, the selection command, the execution command, the performance command, and the stop command is input. In addition, the control panel P may display error information of displaying a problem situation occurring in the laundry treating apparatus, or guide information of guiding an action to be taken by the user.

The cabinet 1 may include the front panel 11 forming a front face of the cabinet 1, and the top panel 13 coupled to a top face of the front panel 11. The front panel 11 and the top panel 13 may be made of a metal material, and may have a steel plate shape.

The control panel P of the laundry treating apparatus of the present disclosure may be coupled to the front panel 11.

The control panel P may be coupled to a rear face of the front panel 11 and may be partially exposed to a front face of the front panel 11. The front panel 11 may be manufactured as a simple metal plate, and the control panel P may be simply coupled to the rear face of the front panel 11 and be fixed.

Accordingly, the front panel 11 may form a most area of the front face of the cabinet 1. As a result, a sense of unity of the front panel 11 may be strengthened and an aesthetics sensation may be maximized. In addition, a process of manufacturing the front panel 11 may be simplified, and a process of assembling or installing the front panel 11 and the control panel P may be simplified. In addition, a separate component such as a frame for mounting the control panel P on the front panel 11 may be omitted.

The control panel P of the laundry treating apparatus of the present disclosure may include a manipulation portion P7 rotatably coupled to the cabinet, and a display portion P8 disposed inside the manipulation portion P7 to display the state of the laundry treating apparatus.

The manipulation portion P7 may be formed in a shape of a rotary knob, and the display portion P8 may be formed as a display D including a liquid crystal or the like. It may be seen that the display portion P8 and a selection portion R to be described later are included in the manipulation portion P7.

The display portion P8 may be entirely formed as a touch panel, or may be at least partially formed as the touch panel.

The manipulation portion P7 may be configured to rotate to select the arbitrary course or option that may treat the laundry, and the display portion P8 may be configured to display a corresponding course or option each time the manipulation portion P7 rotates.

As a result, the control panel P of the laundry treating apparatus of the present disclosure may prevent an arbitrary course or option capable of rotating the drum to be described later from being displayed as characters, guide phrases, and the like in a certain area.

Accordingly, an area or an area ratio occupied by the control panel P in the front panel 11 may be greatly reduced, and the aesthetics sensation may be maximized as no separate characters or guide phrases are attached to the front panel 11.

A display P84 of the display portion P8 may include a state display area D1 for displaying the state of the laundry treating apparatus, and a content display area D2 for displaying the state in which the at least one of the power command, the selection command, the execution command, the performance command, and the stop command of the laundry treating apparatus is input, the error information, or the guide information of guiding the action to be taken by the user.

The state display area D1 may display a lock state D11 illustrating whether the door 113 is locked to the cabinet, an activation state D12 of the communication module T, an executed state of the course or the option, a remote control state D13 by an external terminal, a notification state indicating that there is notification information for the user, or a button lock state D14 in which input of an option selection portion of the manipulation portion P7 or the setting portion P2 is inactivated.

The content display area D)2, as an area displayed with the largest area in the display portion P8, may display the selected state, the executed state, the stop state, and the completion state of the course or the option, and may also display states of other home appliances to be described later.

In addition, the control panel P may further include the selection portion R for the user to input a determination command of determining the information to be displayed on the display portion P8. The selection portion R may be disposed inside the manipulation portion P7 to further reduce an area occupied by the control panel P.

The content display area D2 may vary and display a plurality of state information related to the laundry treating apparatus due to the display P84 including a liquid crystal.

However, the state display area D1 may be provided to intensively and selectively display only specific state information. Accordingly, the state display area D1 may be defined as a state part.

The selection portion R may be disposed inside the display portion P8 and may be disposed spaced apart from the content display area D2. The selection portion R may be formed as a physical button or a touch panel for sensing a contact of a user's body.

The display P84 of the display portion may include an input area D3 that may request an input of the selection portion R at a point corresponding to the selection portion R.

The input area D3 may be configured to emit light when the selection portion R may be activated to receive the command from the user.

In one example, the manipulation portion P7 and the display portion P8 may be operated only when the power is supplied.

To this end, the control panel P of the laundry treating apparatus of the present disclosure may further include the power switch P46 for inputting the power command to the laundry treating apparatus, as well as the manipulation portion P7 and the display portion.

The user may activate the manipulation portion P7 by inputting the power switch P46.

The front panel 11 may include a power switch mounting portion 116 formed such that the power switch P46 may be installed.

In addition, the control panel P may further include the executing means P47 to which the performance command of performing or stopping the selected course or option is input. The executing means P47 may be formed separately from the manipulation portion P7 and the display portion P8 to reflect a definite performance or stop intention of the user. In addition, the functions of the manipulation portion P7 and the display portion P8 may be prevented from being excessive.

The front panel 11 may include an executing means mounting portion 117 formed such that the executing means P47 may be installed.

The control panel P may include one control box or casing P41 that may accommodate or install the power switch P46, the execution device P47, the manipulation portion P7, and the display portion P8 therein.

In one example, the control panel P may further include the setting portion P2 that may add an option to the course or change the option of the course on the front panel 11. The user may set an option capable of changing an intensity, a duration, and the like of the course via the setting portion P2.

The setting portion P2 may be formed separately from the casing P41 and may be coupled to the front panel 11. The setting portion P2 may include a separate liquid crystal and may include a touch panel or a physical button to input the option.

The power switch P46, the executing means P47, the manipulation portion P7, and the setting portion P2 may be collectively referred to as the input means P9.

In one example, the front panel 11 may have the door 112 that opens and closes the laundry inlet into which the laundry is put. The control panel P may be located above the door 112 to enhance accessibility of the user.

In one example, the front panel 11 may further include locking means I, for fixing the door 112 to the front panel 11. When the laundry treating apparatus operates, such as the drum of the laundry treating apparatus rotates, the locking means L may lock the door 112 to the front panel 11. Therefore, a safety accident may be prevented. The locking means L may unlock the door 112 when the operation of the laundry treating apparatus is completed.

The locking means I, may be formed as any component as long as it is able to fix the door 112 to the cabinet 1. The locking means L may be formed as a fastener for fastening a hook protruding from the door, or may be formed as a solenoid valve for holding the hook.

The laundry treating apparatus of the present disclosure may include a detergent box 132 that accommodates therein the detergent for washing the laundry, and the front panel 11 may include a detergent hole P24 from which the detergent box 45 is extended.

The cabinet 1 includes a front panel 11 forming a front face of the laundry treating apparatus. The front panel 11 may include a laundry inlet 111 in communication with the drum 2 and a door 112 pivotably coupled to the cabinet to open and close the inlet 111.

The cabinet 1 may include an opening for disposing the door 112 in an open state and preventing the door 112 from being locked to the cabinet 1.

The opening may include a limiting portion 10b coupled to the door 112 so as to be exposed to the outer circumferential surface of the door 112. The limiting portion 10b may prevent the door from being coupled to the locking portion 10c disposed in the cabinet. Accordingly, the user may dry or ventilate the inside of the drum 2 using the limiting portion 10b of the door when the laundry treating apparatus is not in use.

The front panel 11 has a control panel P. The control panel 117 has input means P9 for receiving a control command from a user, and the display portion P8 that outputs information such as a control command selectable by the user. A main controller M1 for controlling a command to perform a drying cycle of the laundry treating apparatus may be installed.

The input means P9 may include a power supply requesting device P46 for requesting the power supply to the laundry treating apparatus, the manipulation portion P7 that enables the user to select a desired course among multiple courses, and the executing means P47 for requesting start of the course selected by the user.

The display portion P8 may include at least one of a display panel capable of outputting text and figures, and a speaker capable of outputting a voice signal and sound.

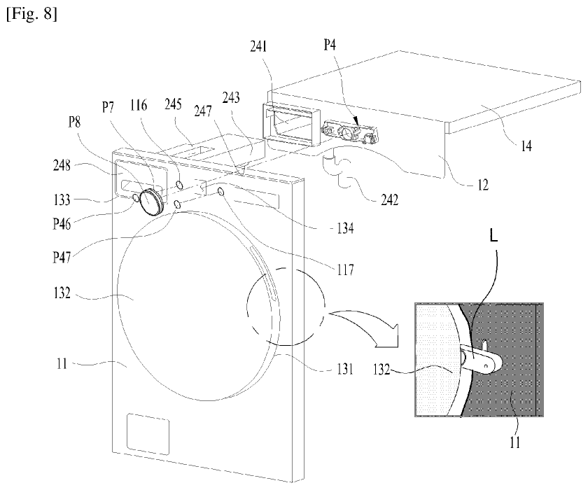

FIG. 8 shows a structure in which a control panel is coupled to a front panel.

As shown in the drawing, the laundry washing apparatus 10 may further include a detergent supply P24. The detergent supply P24 may include a detergent box housing 241 disposed inside the cabinet 1, a connecting pipe 242 for connecting the detergent box housing to the tub body 21, and a detergent box 243 that may be extended from the detergent box housing 241 through a detergent box laundry inlet 133 defined in the front panel 11.

The detergent box 243 may include a chamber 245 that provides a space in which the detergent is stored, and a discharge flow path 247 that discharges the detergent inside the chamber to the detergent box housing 241. The discharge flow path 247 may be formed as a water trap (e.g., a siphon flow path or the like) that allows liquid to flow to the detergent box housing 241 when a level of the liquid stored in the chamber 245 exceeds a preset water level.

When the detergent supply 24 is disposed in the laundry treating apparatus 10, the water supply 23 may further include a nozzle 232 for supplying water to the chamber 245. The nozzle 232 may be fixed to the cabinet 1 to form a top face of the detergent box housing 241, and the water supply pipe 231 may connect the nozzle 232 and the water supply source to each other.

A detergent box panel 248 may be disposed on a front face of the detergent box 243. The detergent box panel 248 may be formed in a shape to close the detergent box laundry inlet 133, and the detergent box panel 248 may have a detergent box handle.

The front panel 11 may be fixed to the cabinet body 11 via a panel support 12. That is, the panel support 12 may be fixed to the cabinet body 11, and the front panel 11 may be fixed to the panel support 12. The panel support 12 may have a detergent box through-hole 121 through which the detergent box 243 passes.

The control panel P may be fixed to the cabinet 1 via the panel support 12. The panel support 12 may have an interface mounting groove into which the control panel P is fixed.

The front panel 11 has a first button mounting portion 136 and a second button mounting portion 137. The first button 461 may be exposed to the outside of the cabinet 1 via the first button mounting portion 136, and the second button 471 may be exposed to the outside of the cabinet 1 via the second button mounting portion 137.

The first input means 46 and the second input means 47 may be separately disposed in a left space and a right space of the display portion 8, may be separately disposed in an upper space and a lower space of the display portion, or may be disposed vertically or horizontally in one of the left space and the right space of the display portion.

The cabinet 1 has a panel through-hole 134 defined to extend through the front panel 11. The shaft 71 may be inserted into the panel through-hole 134.

When the laundry treating apparatus is formed as the laundry dry apparatus 20, the rest may be the same except that the component related to the detergent box is changed to the water storage 7.

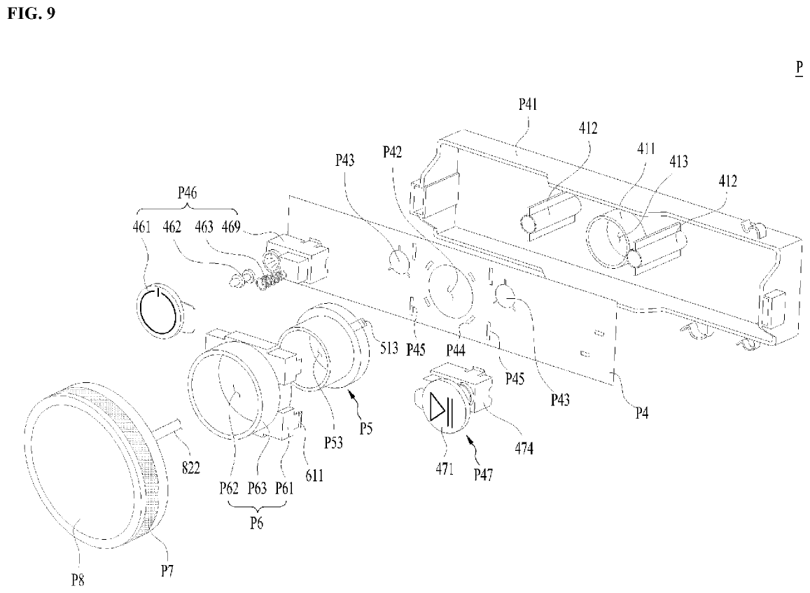

FIG. 9 shows an internal structure of a control panel.

The control panel P includes a control panel or a first circuit board (e.g., a first circuit board) P4 fixed to the panel support 12 and positioned inside the cabinet 1, an encoder P5 fixed to the circuit board and located inside the cabinet 1, the manipulation portion P7 connected to the encoder P5 through the front panel 11, and the display portion P8 fixed to the encoder P5 or the first circuit board P4 through the front panel 11.

The first circuit board P4, as a board equipped with a control circuit required for control (e.g., power control and operation control) of at least one of the drivers 23, 27, and 25, a steam apparatus 200, and a water supply 300, may be fixed to the panel support 12 via the casing P41.

The casing P41 may have any shape as long as it is able to fix the first circuit board 4 to the panel support 12.

The casing P41 may be formed in a hexahedral shape with one face (e.g., a face facing the panel support) open.

A boss for setting a position of the first circuit board P4 may be disposed in the casing P41. The boss may include a first boss 411 and a second boss 412.

In this case, the first circuit board P4 may have a board through-hole P42 through which the first boss 411 passes, and a boss insertion hole P43 through which the second boss 412 passes. The second boss 412 may be disposed in each of left and right spaces of the first boss 411, or may be disposed in each of upper and lower spaces of the first boss 411.

A wire 822 is connected to the display portion P8. The wire 822 may be formed as a power line for supplying the power to the display portion, or may be formed as a communication line that enables the display portion P8 to communicate with devices inside the cabinet including the first circuit board P4.

The first boss 411 may have a first boss through-hole 413 defined therein, and the panel support 12 may have a wire through-hole 123 (see FIG. 4) defined therein. In this case, the wire 822 may be extended into the cabinet 1 by being inserted into the first boss through-hole 413 and the wire through-hole 123.

The first circuit board P4 may further include the power switch P46 and the executing means P47. The laundry device P46 may be formed as means for inputting the control command for requesting the power supply to the laundry treating apparatus 100, and the executing means P47 may be formed as means for inputting a command for requesting execution of the control command displayed on the display portion P8 or a command for temporarily stopping the control command being executed by the laundry treating apparatus 10.

The power switch P46 and the executing means P47 may be configured to generate a control signal by sensing static electricity of the user's body.

The power switch P46 may include the first button 461 exposed to the outside of the cabinet 1, a first detection sensor 464 fixed to the first circuit board P4, and a conductor (e.g., a first touch spring) 463 for connecting the first button and the first detection sensor to each other. Similarly, the executing means P47 may include the second button 471 exposed to the outside of the cabinet 1, a second detection sensor 474 fixed to the first circuit board P4, and a conductor (e.g., a second touch spring) for connecting the second button and the second detection sensor to each other.

The front panel 11 has the first button mounting portion 136 and the second button mounting portion 117. The first button 461 may be exposed to the outside of the cabinet 1 via the first button mounting portion 116, and the second button 471 may be exposed to the outside of the cabinet 1 via the second button mounting portion 117.

The power switch P46 and the executing means P47 may be separately disposed in the left space and the right space of the display portion P8, may be separately disposed in the upper space and the lower space of the display portion, or may be disposed vertically or horizontally in one of the left space and the right space of the display portion.

The first touch spring 463 and the second touch spring may be formed in a shape of a coil, which is to provide a restoring force to the first button 461 and the second button 471. Furthermore, in order to prevent the first button 461 and the second button 471 from being respectively deviated from the button mounting portions 116 and 117, the power switch 46 may have a first stopper 462 that limits a range of motion of the first button, and the execution device 47 may have a second stopper that limits a range of motion of the second button.

The encoder P5 is means for rotatably fixing the manipulation portion P7 to the first circuit board P4, and is means for generating an electrical signal (e.g., or generating an electrical signal set differently based on a rotation angle of an actuator) during the rotation of the manipulation portion P7.

The drying control panel PA may have the same structure as the control panel P.

In addition, the mini control panel PC may also have the same structure as the control panel P.

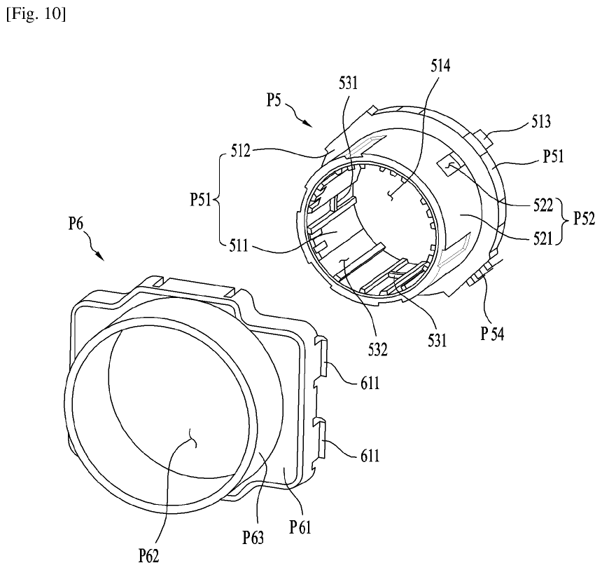

FIG. 10 shows a structure of an encoder.

The encoder P5 may include a fixed portion P51 fixed to the first circuit board P4 and to which the display portion P8 is fixed, a rotating portion P52 rotatably disposed on the fixed portion P51 and to which the manipulation portion P7 is fixed, and a signal generator P54 for generating an electrical signal when the rotating portion P52 is rotated.

The fixed portion P51 may include a fixed body P512 fixed to the first circuit board P4, a support body 511 extending from the fixed body 512 and rotatably fixing the rotating portion P52, and a body through-hole 514 connected to the board through-hole P42 (e.g., connected to the first boss through-hole) through the fixed body and the support body.

The fixed body 512 may be formed in a cylindrical shape. A board fastening portion 513 may be disposed on a circumferential surface of the fixed body 512 or on one face (e.g., a face facing the first circuit board) of the fixed body. In this case, the first circuit board P4 may have an encoder fixing hole P44 defined therein into which the board fastening portion 513 is inserted.

The board fastening portion 513 and the encoder fixing hole P44 may respectively include multiple board fastening portions and multiple encoder fixing holes, and the encoder fixing holes P44 may be arranged to surround the board through-hole P42.

Inside the body through-hole 514, a fastening body fixing portion 531 for fastening the display portion P8 to the fixed portion 51, and a position setting groove 532 for preventing the display portion 8 from rotating (e.g., fixing the position of the display portion) when the display portion P8 is inserted into the body through-hole 514 may be disposed.

The fastening body fixed portion 531 may be formed as a protrusion protruding toward a center of the body through-hole 514 from at least one of the support body 511 and the fixed body 512. The drawing shows a case in which the fastening body fixed portion 531 is disposed on the support body 511 as an example.

The positioning groove 532 may be defined as a groove in which one face of the fixed portion P51 defining the body through-hole 514 is concavely bent. In this case, the positioning groove 532 may be defined along a longitudinal direction of the body through-hole 514.

The rotating portion P52 may be formed as a rotating body 521 rotatably coupled to the support body 511. The rotating body 521 should have a rotating body through-hole through which the support body 511 passes.

The rotating body 521 may have a shaft fastening portion 522 to which the manipulation portion P7 is fastened. The shaft fastening portion 522 may be formed as a fastening hole extending through a circumferential surface of the rotating body 521, or may be formed as a fastening groove defined as the circumferential surface of the rotating body 521 is concavely bent.

The signal generator P54 may include a magnet fixed to the rotating body 521, a sensor that is disposed on the fixed body 512 or the support body 511 to sense a magnetic force, and a terminal that connects the sensor and the first circuit board 4 to each other. The magnet may be formed as multiple permanent magnets are arranged to be spaced apart from each other along the circumferential surface of the rotating body 521.

The first circuit board P4 to which the encoder P5 is assembled may be coated with an insulating material. This is to minimize a possibility that water is supplied to the first circuit board P4 and the circuit is short-circuited. When the insulating material is coated on one face (e.g., a face facing the front panel) of the first circuit board P4, in order to prevent the rotating body 521 from being fixed to the support body 511 by the insulating material, the control panel P may further include an encoder cover P6.

The encoder cover P6 may be formed in a pipe shape that is fixed to the first circuit board P4 and surrounds the encoder P5. That is, as shown in the drawing, the encoder cover P6 may include a fixed body cover P61 that is fixed to the first circuit board P4 and surrounds the fixed body 512, and a cover through-hole P62 defined to extend through the fixed body cover P61 and into which the encoder 5 is inserted.

The fixed body cover P61 may have a board fastening portion 611, and the first circuit board P4 may have an encoder cover fixing hole P45 to which the board fastening portion 611 is fixed. The board fastening portion 611 and the encoder cover fixing hole P45 may respectively include multiple board fastening portions and multiple encoder cover fixing holes, and the encoder cover fixing holes P45 may be arranged to surround the board fastening portion 513.

For discharging water introduced into the fixed body cover P61, a cover outlet 612 may be further disposed on a circumferential surface of the fixed body cover P61. The cover outlet 612 is preferably located at a lowermost end of the circumferential surface of the fixed body cover P61.

In one example, the above-described insulating material is applied to the first circuit board P4 after both the encoder P5 and the encoder cover P6 are coupled to the first circuit board P4, and the insulating material sprayed on a partial area of the first circuit board P4 (e.g., an outer space of the encoder cover) flows into the encoder cover P6 through the cover outlet 612. In such a process, in order to block the insulating material from being supplied to the rotating body 521, a distance L1 from the first circuit board to an uppermost end of the fixed body 512 is preferably set to be equal to or greater than a distance L2 from the first circuit board to an uppermost end of the cover outlet 612.

The encoder cover P6 may further include a support body cover P63 extending from the fixed body cover P61 and surrounding the rotating body 521 (e.g., surrounding the support body). The support body cover P63 may limit the movement of the manipulation portion P7 in a radial direction of the cover through-hole 62, so that the support body cover 63 may prevent the manipulation portion P7 from being separated from the rotating body 521.

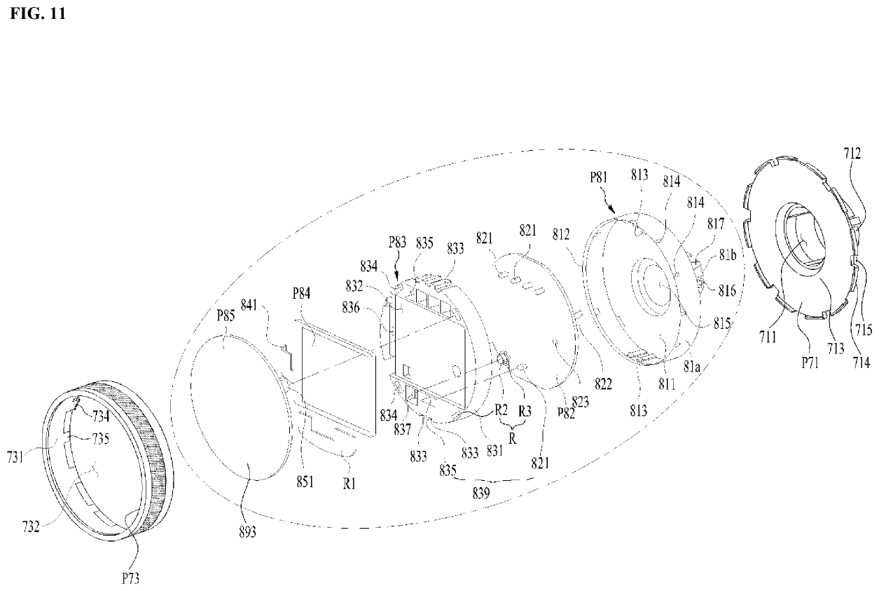

FIG. 11 shows a structure of a manipulation portion and a display portion.

The manipulation portion P7 may include a shaft P71 that is fixed to the rotating body 521 through the front panel 11, and a handle P73 fixed to the shaft P71 and positioned outside the cabinet 1.

The cabinet 1 has the panel through-hole 134 defined to extend through the front panel 11. The shaft P71 may be disposed to be inserted into the panel through-hole 134.

The shaft P71 may be formed a pipe having a shaft through-hole 711 defined therein. The rotating body 521 disposed in the encoder is inserted into the shaft through-hole 711, and a rotating body fastening portion 712 disposed on a circumferential surface of the shaft P71 and positioned inside the shaft through-hole 711 is coupled to a shaft fastening portion 522 disposed on the rotating body. Accordingly, the shaft P71 is fixed to the rotating body 521 via the rotating body fastening portion 712 and the shaft fastening portion 522.

The handle P73 may be fixed to the shaft P71 so as to be located outside of the cabinet 1, and the user may provide a force required for the rotation of the rotating body 521 to the shaft P71 via the handle P73.

The handle P73 may include an accommodation space 731 defined inside the handle to be in communication with the shaft through-hole 711, and a handle through-hole 732 that extends through one face of the handle P73 to allow the accommodation space 731 to be in communication with the outside.

When a diameter of the handle P73 is set to be larger than a diameter of the shaft P71, the shaft P71 may further include a base 713 to which the handle P73 is fixed. The base 713 may be formed as a disk fixed to the circumferential surface of the shaft P71.

The handle P73 and the base 713 may be coupled to each other via a base fastening portion 734 disposed on the handle 73 and a handle fastening portion 714 disposed on the base 713.

The base fastening portion 734 may be formed as multiple protrusions fixed to the handle so as to be located inside the accommodation space 731, and the handle fastening portion 714 may be formed as a groove defined in the base 713 and accommodating the protrusion therein.

In order to facilitate the coupling of the handle P73 and the base 713, the handle P73 may have a fastening guide 735 positioned between one base fastening portion 734 and another base fastening portion 734, and the base 713 may have a guide groove 715 into which the fastening guide 735 is inserted. The guide groove 715 may be defined as a groove in which a circumferential surface of the base 713 is bent toward the shaft through-hole 711.

The display portion P8 may include a housing P81 fixed to the fixed body 512 of the encoder and located inside the accommodation space 731 of the actuator, the display P84 fixed to the housing and displaying information (e.g., information related to control, operation, and the like of the laundry treating apparatus), and a circuit board (e.g., second circuit board and a display portion circuit board) P82 disposed in the housing and having a circuit for controlling the display P84.

The housing P81 may include a fastening body 81b fixed to the fixed body 512 by extending through the shaft through-hole 711 and being inserted into the body through-hole 514, and an accommodating body 81a fixed to the fastening body 81b and positioned inside the accommodation space 731.

The accommodating body 81a may be formed in any shape as long as it may be inserted into the accommodation space 731. A case in which the accommodating body 81a is formed in a cylindrical shape is shown as an example.

A mounting space 811 is defined inside the accommodating body 81a, and the mounting space 811 is in communication with the accommodation space 731 defined in the handle via an accommodating body through-hole 812 (e.g., the accommodating body through-hole is defined to be in communication with the handle through-hole). That is, the accommodating body through-hole 812 is defined in a face directed in a direction in which the handle through-hole 732 is located of the space provided by the accommodating body 81a.

The fastening body 81b may be formed in any shape as long as it is able to be inserted into the shaft through-hole 711 and the body through-hole 514 of the encoder. A case in which the fastening body 81b is formed in a cylindrical shape is shown as an example. The fastening body 81b has a fastening body through-hole 815 connected to the mounting space 811.

A fixed body fastening portion 816 may be disposed on a circumferential surface of the fastening body 81b. The fixed body fastening portion 816 is means for fixing the housing P81 to the fastening body fixing portion 531 disposed in the encoder.

Further, multiple position setting protrusions 817 may be further disposed on the circumferential surface of the fastening body 81b.

The position setting protrusion 817 is formed in a shape capable of being inserted into the position setting groove 532 defined in the encoder, and the position setting protrusion 817 is disposed at a point corresponding to a position of the position setting groove 532. The position setting protrusion 817 and the position setting groove 532 are means for minimizing a risk that the fixed body fastening portion 816 fails to be coupled to the portion 531 (e.g., means for ensuring the coupling of the fixed body fastening portion and the fastening body fixing portion) when the fastening body 81b is inserted into the body through-hole 514.

The second circuit board P82 may be inserted into the mounting space 811, and the wire 822 connected to the second circuit board P82 may be withdrawn to the outside of the housing P81 through the fastening body through-hole 815. Multiple lamps 821 may be disposed on the second circuit board P82.

The second circuit board P82 may control the display P84 to display preset information in response to an electrical signal generated from the signal generator 54 when the handle P73 is rotated.

In order to maintain a gap between the second circuit board P82 and the display P84 and to prevent damage to the lamp 821, a mounting portion P83 positioned between the display P84 and the second circuit board P82 may be disposed in the mounting space 811.

The mounting portion P83 may be formed as a mounting body 831 fixed to the accommodating body 81a and positioned inside the mounting space 811. The mounting body 831 may have any shape as long as it is able to be inserted into the mounting space 811.

A seating groove 832 to which the display P84 is fixed is defined in one face of the mounting body 831. The seating groove 832 may have a connector through-hole 836. A connector 841 (e.g., a flexible printed circuit board (PCB) or the like) disposed in the display P84 may be connected to the second circuit board P82 by being inserted into the connector through-hole 836.

The mounting body 831 may have a lamp through-hole 835 into which the lamp 821 is inserted. It is preferable that the number of lamp through-holes 835 is the same number as the number of the lamps 821, and a position of the lamp through-hole 835 should be set to a space of the mounting body located above the mounting groove 832 or a space of the mounting body located below the mounting groove 832. This is for light emitted from the lamp 821 to be transmitted to the outside of the housing P81 through the lamp through-hole 835.

The mounting portion P83 is fixed to the housing P81 via a mounting body fastening portion 813 disposed on the accommodating body 81a and an accommodating body fastening portion 833 disposed on the mounting body 831. The mounting body fastening portion 813 may be formed as multiple protrusions located inside the mounting space 811, and the accommodating body fastening portion 833 may be defined as a groove or the like defined in the circumferential surface of the mounting body 831 (e.g., one face of the mounting body in contact with the accommodating body) and to which the mounting body fastening portion 813 is fixed.

The number of mounting body fastening portions 813 and the number of accommodating body fastening portions 833 should be set to be the same, and positions of the mounting body fastening portion 813 and the accommodating body fastening portion 833 should be set to correspond to each other.

In order to increase a fastening force of the mounting body 831, the accommodating body fastening portion 833 may include an upper fastening portion positioned higher than the seating surface 832 and a lower fastening portion positioned lower than the seating surface 832. Unlike the drawing, the accommodating body fastening portion 833 may be disposed on each of left and right sides of the seating face.

A cover P85 may be further disposed on the accommodating body 81a to prevent water and foreign substances from flowing into the display P84 and the second circuit board P82.

Preferably, the cover P85 is fixed to at least one of the accommodating body 81a and the mounting body 831 to close the accommodating body through-hole 812. The cover P85 should be made of a material having a transparency that allows the information displayed on the display P84 and the light emitted from the lamp 821 to be viewed from the outside.

When the cover P85 is fixed to the mounting body 831, the cover P85 may have a cover fixing protrusion 851 protruding toward the mounting body 831, and the mounting body 831 may have a fixing protrusion fastening portion 834 to which the cover fixing protrusion 851 is coupled.

The second circuit board P82 may also be fixed to the mounting body 831. That is, the mounting portion P83 may have a protrusion 838 protruding from the mounting body 831 toward the second circuit board 82, and the second circuit board 82 may have a protrusion through-hole 823 into which the protrusion 838 is inserted.

Further, the cover P85 may further include a cover sheet 853 for lowering the transparency of the cover. It is preferable that a transparency of the cover sheet is set to such a degree that it is difficult to view the interior of the mounting space 811 from the outside (e.g., the transparency of the cover sheet is set lower than the transparency of the cover). The cover sheet 853 may be fixed to a surface of the window P85, and a letter or symbol H may be displayed in an area of the cover sheet on which the lamp through-hole 835 is projected.

In one example, a lamp through-hole 835 corresponding to the input area D3 among the lamp through-holes 835 in the mounting portion P83 may provide a signal instructing the user to press the input area D3.

The selection portion R for receiving a control command of selecting the control command displayed on the display 84 may be further disposed on the control panel P.

The selection portion R may be configured to determine whether the control command displayed on the display P84 is selected by sensing whether the user's body is in contact with the cover P85.

That is, the selection portion R may include a sensor R3 disposed on the second circuit board 82 and sensing the static electricity of the user's body, and a conductor R2 or a physical button R1 for connecting the sensor R3 and the cover P85 to each other.

The selection portion R may be composed of a receiver R1 attached to or coupled to the window P85, and a transmitter R2 having one end connected to the receiver R1 and the other end connected to the sensor R3. In this case, the mounting body 831 must have a conductor through-hole 837 into which the transmitter R2 is inserted.

The receiver R1 is means for facilitating the input of the control command by expanding an area that the user may contact. In the control panel P having the above structure, the display area D1 is formed in an upper space of the cover P85, and the input area D3 is formed in a lower space of the cover P85. Therefore, when a width of the receiver R1 is set to be great, a width of the input area D3 is expanded, so that the user may more easily input the control command. The width of the receiver R1 is preferably set to equal to or smaller than ¼ to ½ of a width of the cover P85.

The transmitter R2 and the receiver R1 may be formed as a conductor. Therefore, when the user's body is in contact with the transmitter R2 and the receiver R1, a current of the user's body may be charged or transmitted, so that the current may be transmitted to the sensor R3.

In addition, the transmitter R2 and the receiver R1 may be formed physical buttons. Therefore, when the user's body presses the receiver R1, the pressure of the body may be transmitted to the sensor R3.

In one example, the display portion P may include inducing means 839 for inducing the user to press the selection portion R.

The inducing means 839 may guide the user to the location of the selection portion R to induce the user to press the selection portion R.

The inducing means 839 may include the lamp 821 and the lamp through-hole 835 corresponding to the position of the receiver R1. Specifically, the inducing means 839 may include the lamp through-hole 835 defined below the display P84 and the lamp 821 installed inside the lamp through-hole 835.

The lamp through-hole 835 and the lamp 821 constituting the inducting means 839 may be disposed below the display P84 and at a center of the mounting portion 83.

Accordingly, when the lamp 821 emits the light in the inducting means 839, the selection portion R or an area adjacent to the selection portion R may be brightened.

In addition, the lamp 821 of the inducing means 830 may be formed as an LED element and the like to indicate a separate character or phrase.

The control panel P having the above structure enables display of the control command, search for the displayed control command, and selection of the displayed control command, and enables minimization of a space required for installation. However, the control panel P having the above structure needs means to block the inflow of water or the foreign substances to the display portion P8 and the manipulation portion P7 or to discharge the inflowed water or foreign substances to the outside.

The control panel P having the above structure will display a preset control command on the display P84 whenever the user rotates the handle P73 (e.g., whenever the encoder generates the electrical signal) (e.g., search and change the control command).

When the desired control command is displayed on the display P84, the user may select the displayed control command via the selection portion R, and the control command selected via the selection portion R may be initiated when the user inputs an execution command via the executing means P47.

In one example, the handle P73 is coupled to the first circuit board P4 to enable a rotational movement, whereas the housing P81 of the display portion is fixed to the first circuit board P4, so that it is necessary to keep a gap between the handle P73 and the housing P81 constant. This is because, when the gap between the handle P73 and the housing P81 is not maintained, the rotation of the handle 7P3 is likely to be constrained.

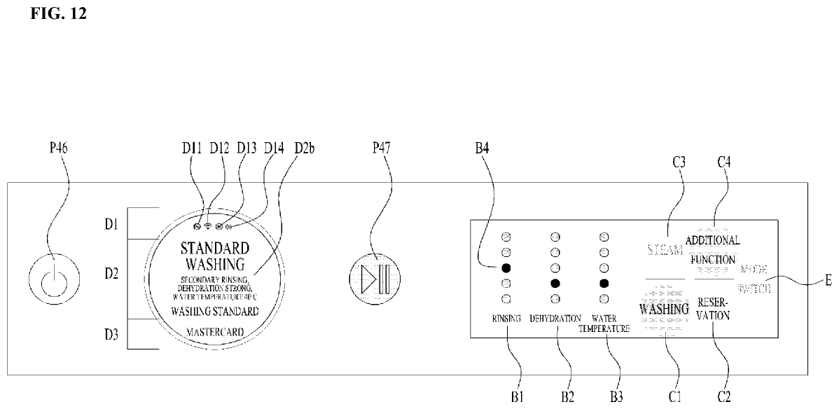

FIG. 12 is a shows utilization of the control panel.

In the state display area D1 of the display portion P8, whether the door is locked, whether the communication module is activated, whether the course or the option is operated, whether the guide phrase is generated, or the like may appear in a form of an icon.

In addition, the number of displayed contents that may appear while rotating the manipulation portion P7 may be displayed in the state display area D1. For example, a plurality of dots may be arranged to be spaced apart from each other, and the number of contents displayed in the content display area D2 may be provided while one of the plurality of dots emits the light.

In the content display area D2, contents of the course and the option, the executed state of the course or the option, and the guide phrase necessary for the user may be displayed.

The content display area D2 may be larger than the state display area D1.

In the input area D3, light may be emitted to request the input of the user, and the guide phrase indicating which content the user should input may be displayed.

The power switch P46 may be disposed at a left side of the display portion P8, and the executing means P47 may be disposed at a right side of the display portion P8.

The manipulation portion P7 may be rotatably disposed on an outer circumferential surface of the display portion P8, and may rotate the drum 2.

The arbitrary course may be a series of control methods for performing the washing cycle (e.g., the drying cycle) of washing the laundry.

When the manipulation portion P7 is rotated, a name of the corresponding course and a simple option name may be displayed in the content display area D2 of the display portion P8 based on a set order, and a description of the course or the option may be displayed.

The option may be selected by the setting portion P2. The setting portion P2 may be configured to receive a selection command for selecting at least one of the arbitrary options.

The arbitrary option may include setting additional conditions of the course.

For example, the arbitrary option may be a set algorithm or a control method for adjusting at least one of the number of repetitions of each cycle to perform the course, an intensity of performing each cycle, a rotation speed of the drum when performing each cycle, a temperature of water, an amount of water, and a duration of each cycle.

The setting portion P2 may be formed as a touch display for selecting the arbitrary option, and may have a plurality of lamps and a plurality of conductor switches capable of sensing the user's body.

For example, the setting portion P2 may include option selection portion B that receives a setting command to set the conditions for the course, and option display portion B4 that displays option information corresponding to the option selection portion B.

For example, the option selection portion B may include rinsing means B1 for adjusting a rinsing force related to the rotation speed and duration of the drum, the amount of water, and the number of times of rinsing when the course performs the rinsing cycle, dehydration means B2 for adjusting a dehydration force related to the rotation speed and duration of the drum when the course performs the dehydration cycle, and temperature means B3 of adjusting a temperature of water when the course performs the washing cycle.

The option display portion B4 may be configured to indicate the rinsing force, the dehydration force, and the temperature in an objectified and unitized manner.

In one example, the setting portion P2 may have a utilizing means C that receives a utilization command to utilize a function of the laundry treating apparatus.

For example, the utilizing means C may include washing means C1 for inputting a special washing cycle such as functional laundry washing, soft laundry washing, and tub washing, reservation means C2 for inputting a reservation command to perform the washing course at a specific time, sterilizing means C for promoting sterilization by adding steam to the laundry during the course cycle, and additional function means C4 for utilizing additional functions such as pairing with other devices.

In addition, the setting portion P2 may include switching portion E for receiving a connection command to be in communication with the laundry dry apparatus 20 or the mini apparatus 60.

In one example, the setting portion P2 allows a function that may be utilized at a present time point or a function selected by the user to be turned on and allows a function that is not able to be executed or is not selected by the user to be turned off.

The setting portion P2 may display all of the contents via an auxiliary display P19.

Hereinafter, an embodiment and a control method for displaying and controlling the laundry dry apparatus 20 or the mini apparatus 60 with the control panel P of the laundry washing apparatus 10 will be described. However, this is only for omitting repetitive descriptions, and is able to be equally applied when controlling the laundry washing apparatus 10 or the mini apparatus 60 with the drying control panel PA.

In addition, the same may be applied when controlling the laundry washing apparatus 10 or the laundry dry apparatus 20 with the mini control panel PC.

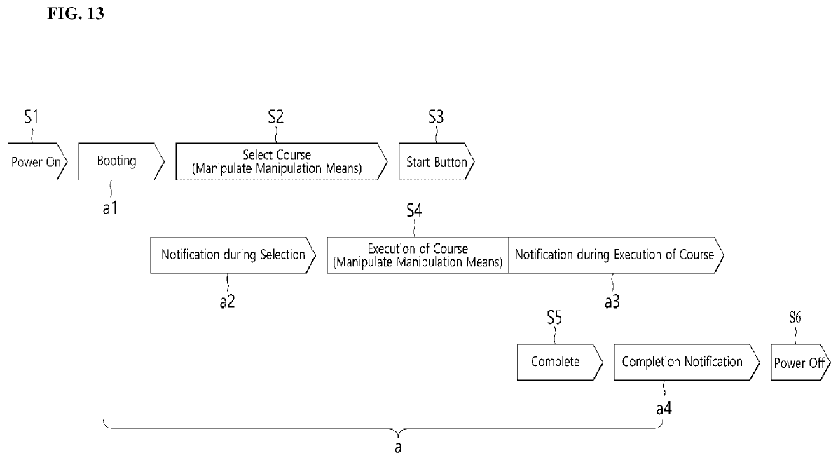

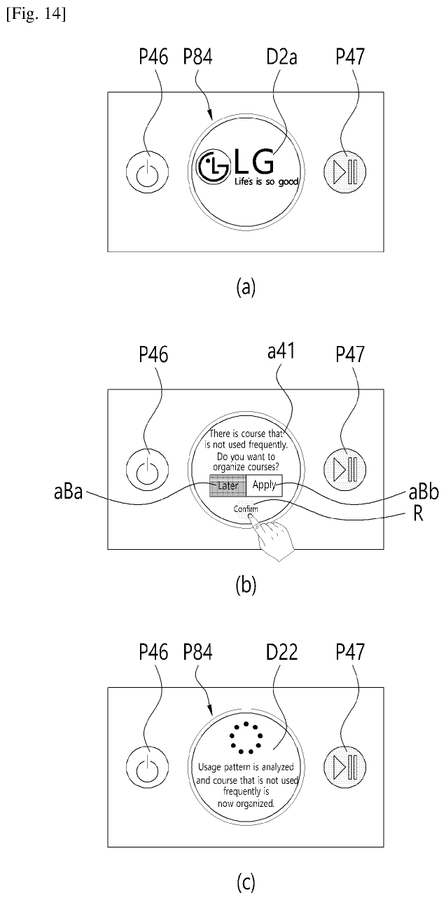

FIG. 13 shows a notification point when a notification is generated in a laundry treating apparatus according to the present disclosure.

The laundry washing apparatus 10 may perform a power step S1 in which a signal of the power switch P46 is input to supply power to the control panel P. When power is supplied to the control panel P to supply power to the display portion P8 and the manipulation portion P7, a selection stage S2 of selecting a course and an option by manipulating the manipulation portion P7 may be performed.

When the course and the option are selected, an execution step S3 of executing a course and option that are selected by inputting a signal of the executing means P47 may be performed. Then, a course execution step s4 of washing laundry by performing the course and the option according to an algorithm may be performed.

When a completion step S5 of completely executing the course and the option is performed, a blocking step S6 of blocking standby power as power of the control panel P is shot off may be performed.

The laundry treating apparatus according to the present disclosure including the laundry washing apparatus 10, the laundry dry apparatus 20, and the mini apparatus 60 may be commonly operated in the following method.

In the laundry treating apparatus 10 according to the present disclosure, there may be a need to notify the user when a notification is generated.

For example, a storage of the control panel P may store information required to notify the user while executing a previous course and option. There may be a need to download a new course and option from the server 50 and to recommend or guide the new course and option to the user. In addition, it may be necessary to receive weather information from the server 50 or the external terminal 40 to recommend a suitable course and option. In addition, there may be a need to notify the user when a problem occurs while the course and option are executed.

As such, when various notification information to be notified to the user is generated, the control panel P may generate notification information ‘a’ that guides the user through a component for visually or aurally checking of the user, such as the display portion P8 or a speaker K1, and may display the notification information ‘a’ during each control step.

The notification information ‘a’ may be displayed at a time point a1 of booting the control panel P to display or receive control information in the power step S1, may be displayed at a time point a2 of selecting and executing the course and the option, may be displayed at a time point a3 of executing the course and the option, and may be displayed at a completion time point a4 of the course and the option to the user.

In detail, notification information may be generated by checking an external signal received from a server of the control panel P, an external terminal, and the like, and an internal state of the driver 28, the steam part 200, the water storage 7, the water supply 23, the drainage 25, the communication module T, etc. inside the cabinet. The control panel P may generate notification information in response to the external signal, and may check the internal state to generate notification information corresponding thereto. A detailed example of the notification information will be described below.

In the laundry treating apparatus according to the present disclosure, the display portion P8 may be controlled to display the notification information at any one of the booting time point a1 of supplying power to the display portion, the selection time point a2 of the course or the option to be input by the manipulation portion, the execution time point a3 of executing the course or the option, and the completion time point a4 of completing the course or the option.

The notification information may include notification information that may be displayed in any situation of the booting time point a1, the selection time point a2, the execution time point a3, and the completion time point a4.

However, an effect of notification may be maximized when the notification information is displayed at a specific time among the booting time point a1, the selection time point a2, the execution time point a3, and the completion time point a4.

Accordingly, in the laundry treating apparatus of the present disclosure, when the notification information is generated, a notification criterion for determining when to display the notification information may be set, and the notification information may be displayed at an accurate time according to the notification criterion.

The notification information may include condition information indicating that a condition necessary for executing a course or option that the laundry treating apparatus is capable of performing is insufficient.

The condition information needs to be displayed before the execution time point a3, and thus the user may take a necessary action to accurately perform the course and the option.

The type and list of the condition information may be further increased and stored in the storage S when the type and the list of the condition information are necessary conditions during execution of the course or the option, or may be changed.

For example, the condition information may include #1 of detergent information indicating that the amount of detergent is insufficient in the detergent box, and may include #2 of softening agent information indicating that the amount of the softening agent is insufficient in the softener box.

The condition information may include #3 of integrated information for notifying at the same time without performing a plurality of notifications when the amount of the detergent and softening agent is insufficient.

Accordingly, when a plurality of notification information needs to be displayed in a situation in the case of one display portion P, the laundry treating apparatus according to the present disclosure may also display entire notification information in one bundle at once.

The condition information may be displayed at the booting time point a1 or the selection time point a2. When there is separate notification information to be displayed at the booting time point a1, the condition information may be displayed at the selection time point a2 and may induce the user to recognize this and act on the course and the option before the course and the option are performed.

The notification information may include recommendation information for recommending a specific course or option to the user.

#4 to #7 indicates an example of a list of recommendation information generated in the laundry washing apparatus 10. The list of the recommendation information may be updated or changed through the communication module T.

The recommendation information may include inside information generated by checking the internal state of the laundry washing apparatus 10 as in #4 and may include outside information generated by receiving a signal from the outside of a cabinet as in #5 to #6.

The recommendation information may be used to recommend any one course and option among arbitrary courses and options to the user. For example, the recommendation information may include tub washing information for recommending a tub washing course as in #4.

When a history of washing without tub washing more than 30 times is stored in the storage S, a tub sterilization course for performing the tub washing may be recommended.

The recommendation information may include course arrangement information such as deletion and rearrangement of courses and options, e.g., removal of a turn in which a course that is not frequently used as in #5 is displayed on the display portion P8 or positioning of the course in a lower priority during rotation of the manipulation portion P7.

The recommendation information may be used to recommend suitable course and option after receiving weather information as in #6 and #7. For example, the recommendation information may include dewatering information that induces further increase in spin-drying intensity related to a rotation speed of a drum or a rotation time of the drum during dewatering by considering that laundry is less dry because humidity is high as in #6.

The recommendation information may have rinsing information that induces further increase in a rinsing intensity or frequency related to the number of rinsing cycles or the amount of rinsing water during rinsing because there is a lot of fine dust as in #7.

The recommendation information may be displayed at the booting time point a1 or the selection time point a2. When there is separate notification information to be displayed at the booting time point a1, the recommendation information may be displayed at the selection time point a2 and may induce the user to recognize this and to select the recommended course or option before the course and the option are performed.

The condition information and the recommendation information may not necessarily be a condition required to perform the course or the option.

In other words, when the user ignores the condition information and the recommendation information and intends to enforce the selected course and option, the laundry treating apparatus may have no problem until the course or the option is executed and completed.

That is, even if the condition information is displayed because there is no detergent or softening agent, it may be possible to wash with water as long as water supply and drainage are possible. There is no problem in that the course or option selected by the user is performed even if the user does not select the recommended course or option.

Accordingly, even if the condition information and the recommendation information are displayed on the display portion P8, when confirmation intention that the user has confirmed the condition information and the recommendation information is input through the selection portion R, the condition information and the recommendation information may be removed from the display portion P8.

Button name display in the above table may indicate whether it is possible to input content for inputting confirmation intention to the selection portion R. The ‘Confirm’ may mean that the notification information appears when the confirmation intention of the user is input.

Even if the condition information and the recommendation information are displayed, when a signal of the executing means P47 is input, the condition information and the recommendation information may be removed from the display portion P8.

Even if the condition information and the recommendation information are displayed, when a reference time or more elapses, the condition information and the recommendation information may be removed from the display portion P8. For example, the reference time may be set from 30 seconds to 3 minutes or less. This is because, when the user does not take an action to satisfy the conditions during the reference time or does not select a recommended course, it may be seen that the user has no intention to reflect the notification information. Accordingly, the notification information may be removed to prevent laundry delay.

Needless to say, the condition information may be removed from the display portion P8 when it is detected that the user takes an action to satisfy the guided condition. For example, when the detergent or the softening agent are supplied. #1 and #2 of the condition information may be removed from the display portion P8.

Whether the detergent or the softening agent is supplied may be recognized by detecting a weight of the detergent box, may be recognized through a water level sensor inside the detergent box, or may be recognized by detecting that the detergent box is withdrawn and then inserted. A plurality of the condition information and a plurality of the recommendation information may be displayed.

For example, humidity may be high without detergent, and the number of washings may be more than 30 times without a detergent and a softening agent.

In this case, when all notification information is displayed on the display portion P8, it may be difficult for the user to check all the notification information.

The display portion P8 may be disposed inside the manipulation portion P7, and thus an area of the display portion P8 may not be larger than that of a relatively general display liquid crystal. Accordingly, when all of the generated notification information is displayed on the display portion P8, the user may have trouble checking all of the notification information. Furthermore, a laundry delay 10 may occur, which may rather cause inconvenience to the user.

Therefore, in order to prevent this, the notification information may be set to be displayed in the display portion P8 in less than a reference number. For example, when the notification information is generated in a reference number, the notification information may be integrally displayed or sequentially displayed on the display portion P8. However, when the notification information is generated in a reference number of more, the control panel P may prioritize the notification information to display only the reference number of notification information and may ignore the remaining notification information or may store the remaining notification information in the storage S to display the remaining notification information at the next booting time point a1.

For example, when the condition information #1, the condition information #2, the recommendation information #4, and the recommendation information #6 are generated and the reference number is 2, the display portion P may display the condition information #1 and #2 or may display integrated condition information obtained by integrating #1 and #2 as in #3 and may remove the notification information #4 and #6.

Accordingly, the user may check only the most necessary notification information among the generated notification information and may operate the laundry treating apparatus.

The condition information and the recommendation information may have a priority set in advance. The priority information may be the same as the table above.

The same way as the laundry washing apparatus 10 may also be applied to the laundry dry apparatus 20 and the mini apparatus 60.

FIG. 14 shows an embodiment in which booting information is displayed on the display portion P8 at the execution time point.

Referring to (a) of FIG. 14, when a signal of the power switch P46 is input, the control panel P may start booting. During this process, the display portion P8 may display that the display portion P8 is booting by displaying a manufacturer's logo, a booting icon, or the like.

Referring to (b) of FIG. 14, the control panel P may recognize that a specific course or option is not performed while the user operates the laundry treating apparatus 30 times. In addition, the control panel P may discover that a history in which the specific course or option is not performed is stored in the storage S.

The control panel P may display course arrangement information a41 on the display P84 of the display portion P8.

The course arrangement information a41 may include an additional selection option that asks whether to arrange now or determine again later as well as the selection portion R input that requires confirmation from the user.

Requesting whether to determiner again later may be indicated by a later icon aBa, and requesting whether to determine to arrange now may be indicated by an application icon aBb.

Initially, the later icon aBa may be set to be selected. Accordingly, the user may input a signal of the selection portion R to select the later icon and to induce the course arrangement information a41 to be removed from the display portion. Accordingly, it is possible to prevent delay in execution of the course and option.

However, the user may change the application icon to be selected by inputting a signal of the manipulation portion P7, and may request to arrange courses or options by entering the selection portion R.

Referring to (c) of FIG. 14, the control panel P may display an unused course or option on the display portion P8 later by operating the manipulation portion P7 or may arrange courses or options not to be selected by the manipulation portion P7 by moving the unused course or option to a lower priority.

It may be possible to display the course or the option being organized as arrangement guide D)22 in the display P84 of the display portion P8. The arrangement guide D22 may include an icon and a phrase indicating that a program is being processed.

Accordingly, the recommendation information may be displayed before the course or the option is selected by the manipulation portion P7, and the user may ensure convenience when operating the laundry treating apparatus next time.

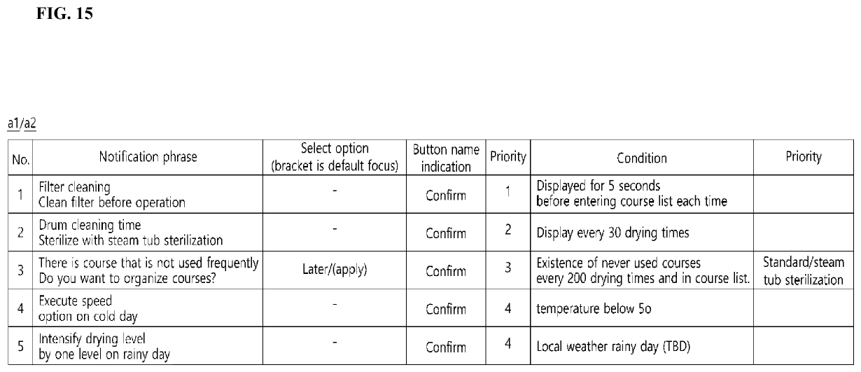

FIG. 15 shows a type and a reference of notification information displayed at a booting time point or a selection time point in the laundry dry apparatus 20.

The notification information may include condition information indicating that a condition necessary for performing a course or option that the laundry treating apparatus is capable of performing are inadequate.

For example, the condition information may include filter information #1 that requires cleaning of a filter.

The filter information may be set to be displayed for a set time before the course and option are executed. The set time may be 5 seconds. Thereby, filter cleaning may be induced, drying efficiency may be increased by inducing hot air to easily pass through the filter, and foreign substances may be prevented from decaying in the filter.

The notification information may include recommendation information for recommending a specific course or option to the user.

The recommendation information may include sterilization information #2 to recommend a tub sterilization course to sterilize a drying drum with steam to the user. The recommendation information may include arrangement information #3 such as deletion and rearrangement of courses and options, e.g., removal of a turn in which a course that is not frequently used is displayed on the display portion P8 or positioning of the course in a lower priority during rotation of the manipulation portion P7.

In addition, the recommendation information may include speed information #4 to ensure drying performance by driving a compressor faster than before entering a general course or option when the temperature is low and increasing a temperature of a refrigerant.

The recommendation information may include strength information #5 that recommends increasing the dry strength related to the temperature and drying time of hot air based on the weather information received from the external terminal 40 or the server 50.

When the user's confirmation is input, the condition information and the recommendation information of the laundry dry apparatus 20 may also be set to be removed from the display portion P8, and when the reference time elapses, the condition information and the recommendation information may be set to be removed from the display portion P8.

In addition, a priority of the condition information and the recommendation information may already be set. Accordingly, when the reference number or more of the condition information and the recommendation information are generated, the condition information and the recommendation information corresponding to the reference number may be displayed on the display portion P8 according to the priority.

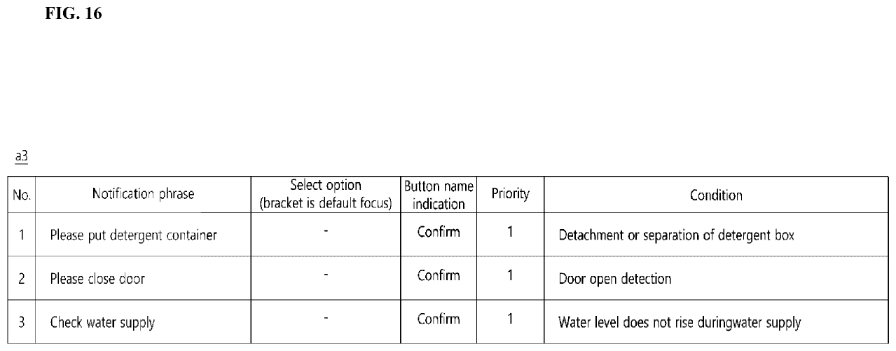

FIG. 16 shows a type and a reference of notification information displayed at an execution time point.

The notification information may include action information indicating that the course or the option is not capable of being continued or is not capable of being executed.

The action information may be notification information displayed to the user when a reason why an operation of the laundry treating apparatus is not capable of being continued occurs, unlike the condition information and the recommendation information.

For example, the action information may include separation information #1 indicating that the detergent box is separated from the cabinet 1. As such, the user may install the detergent box back into the cabinet 1.

The action information may include door information #2 for inducing the door to be locked by detecting that the door is opened.

The action information may include water supply information #3 that requests confirmation of a water supply state when an external water supply source is not capable of supplying water to the tub 2, e.g., when the water supply valve is locked or when a water level of the tub does not rise during water supply control.

The action information may be information that does not allow the user to ignore and enforce a situation, unlike the condition information and the recommendation information. Accordingly, the action information may not be information to be removed from the display portion P8 by simply receiving the user's confirmation intention through the selection portion R.

Accordingly, the action information displayed on the display portion P8 may be set to disappear only when the user directly takes a corresponding action for removing the action information.

The action information may have a higher priority than the condition information and the recommendation information. Accordingly, when the notification information includes the action information, the condition information, or the recommendation information, the action information may be controlled to be preferentially displayed on the display portion P8.

Needless to say, the action information may be set to be all displayed on the display portion

P8, or may be set to be displayed sequentially.

To this end, in the case of the action information, when confirmation intention is input through the selection portion R, input of the selection portion R may also be activated in order to indicate next action information. Even if the action information disappears from the display portion P due to input of the selection portion R, when a corresponding action is not performed, an execution state of the course or the option may be stopped, and the action information may be displayed on the display portion P8 again.

However, the action information may be generated in an error condition when the course or the option is executed. Accordingly, when the action information may be generated in the error situation and displayed on the display portion P8, the user may take an action.

For example, the user may solve an appropriate action according to the action information by mounting the detergent box in the cabinet 1 or locking the door 112 to the cabinet 1. When the cause of generating the action information is resolved, the control panel P may remove the action information displayed on the display portion P8.

Needless to say, the action information may be generated when the course or the option is not capable of being performed, and thus when this situation is detected in advance, the action information may also be generated at the booting time point or the selection time point.

Even if the action information is generated, when the user does not take an action and inputs a signal of the control panel P, the user may be determined not to recognize the action information.

Thus, the control panel P may reproduce an image corresponding to the action information on the display portion P8 or may display a QR code for displaying access information of a site in which the image is capable of being checked. Accordingly, it may be possible to induce the user to know exactly how to solve the above measures.

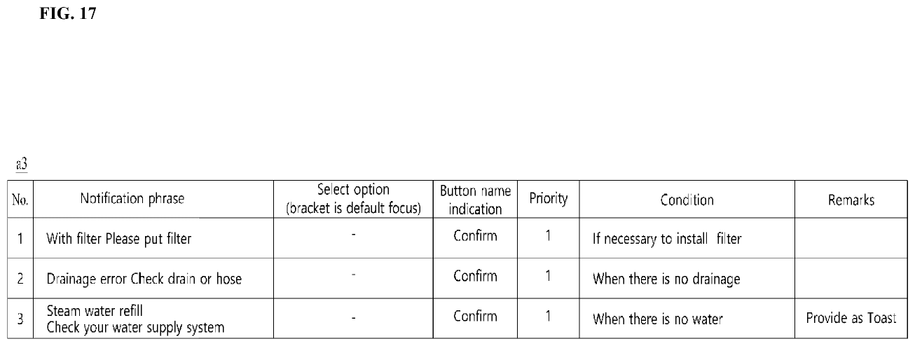

FIG. 17 shows a type and a reference of notification information to be displayed at an execution time point in the laundry dry apparatus 20 shown in FIG. 16.

In the laundry dry apparatus 20, the action information may include installation information #1 that requests to install the filter when the filtration means 5 is separated from the drying cabinet 1.

The action information may include tank information #2 that requests to install the water storage tank when the water storage tank is separated from the drying cabinet 1.

The action information may include steam information #3 that requests to check the water supply 300 when it is not possible to generate steam because water is not supplied to the steam part 200.

However, the action information may be generated in an error condition when the course or the option is executed. Accordingly, when the action information may be generated in the error situation and displayed on the display portion P8, the user may take an action.

For example, the user may solve an appropriate action according to the action information by mounting the filtration means 5 in the drying cabinet 1, mounting the water storage tank in the drying cabinet 1, or filling water in the water tank 430.

The control panel P may remove the action information displayed on the display portion P8 when a cause of generating the action information is resolved.

Needless to say, the action information may be generated when the course or the option is not capable of being performed, and thus when this situation is detected in advance, the action information may also be generated at the booting time point or the selection time point.

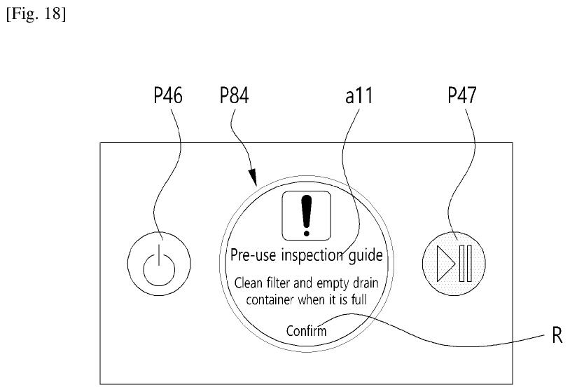

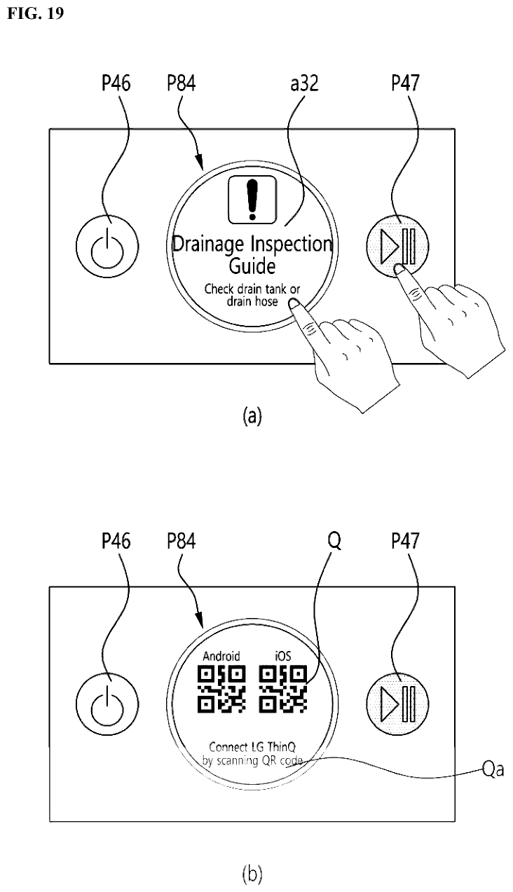

FIG. 18 shows an embodiment in which the execution information is displayed on the display portion P8.

In the laundry dry apparatus 20, a water reservoir may be at a full water level at the execution time point a3 during execution of the course and the option.

In other words, the water storage 7 may no longer be able to accommodate condensate.

In this case, when the drying course or option is continuously executed, a safety accident such as overflow of water inside the laundry dry apparatus 20 may occur.

Accordingly, the control panel P may display tank information a32 on the display portion P8.

Since the tank information a32 corresponds to the action information, the tank information a32 may be configured not to remove the tank information a32 by inputting a separate command to the control panel P by the user.

In other words, input of the selection portion R may be inactivated, and display of the “Confirm” may be removed.

Accordingly, the user may recognize that the action information is not capable of being resolved through input of the control panel P. As a result, the user may peruse the action information and may solve the cause of the action information. That is, the user may take an action to empty water of the water storage 7 and to collect condensate again.

The term of the water storage 7 may also be displayed by being converted to a drain tank or a drain hose to allow the user to easily recognize this.

(a) and (b) of FIG. 19 show the case in which a user does not take an action even if action information is generated.

Referring to (a) of FIG. 19, even if the tank information a32 is generated, the user may manipulate the control panel P of the display portion P8, the executing means P47, or the like.

(b) of FIG. 19 shows the case in which the control panel P displays a QR code Q for checking an image including an action for removing action information such as the tank information a32 on the display portion P8 when a reference number or more of manipulation commands are input. The control panel P may also display a use guide Qa of the QR code.

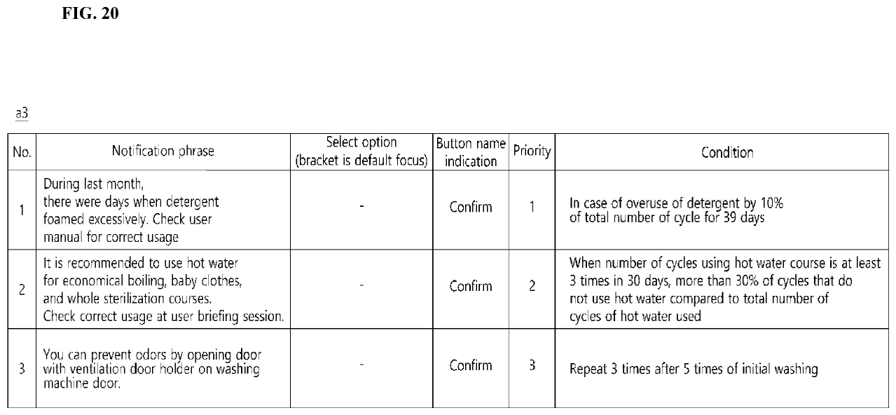

FIG. 20 shows a type and a reference of notification information to be displayed at a completion time point.

The completion time point a4 may be notification information displayed after the course or the option is completed.

Thus, notification information at the completion time point a4 may correspond to evaluation of execution of the course or the option or evaluation of a history of using the course or the option so far.

The notification information at the completion time point a4 may correspond to information that recommends specific information to the user after the course or the option is executed.

For example, the notification information may include correction information that induces the user to correct a method for using the course or the option.

The correction information may include a guide according to a type of a corresponding error when the user erroneously uses the laundry washing apparatus 10. For example, the user may have a wrong habit, such as excessively adding a detergent or a softening agent when washing laundry.

When the wrong habit is repeatedly performed for a specific period, the control panel P or the server 50 may determine that the wrong habit needs to be corrected.

For example, when the correction information may include detergent information #1 that recommends the user to input an appropriate amount of detergent when the detergent is used excessively.

For example, when detergent foam is generated more than a reference value during a rinsing process, the control panel P may recognize that the user uses the detergent in excess of the appropriate amount. In addition, it is not temporary, but when the detergent foam is generated during a specific period such as a month, it may be determined that correction of the user is necessary.

The control panel P may generate the detergent information #1 that recommends the user to reduce the amount of the detergent and may display the detergent information #1 on the display portion P8. For example, the correction information may be a guide to check a user manual because detergent foam is excessively generated for one month.

The correction information may include hot water information #2 that recommends the user to use hot water. When the user executes an allergy course, a baby clothes course, a tub washing course, or the like, an external water supply source for supplying water temperature and the water supply 23 may not be connected to each other. Thus, even if the course using water temperature is performed, when the control panel P discovers that water temperature is not supplied, the control panel P may display the hot water information #2 at the completion time point a4.

Thereby, laundry delay may be prevented by preventing indefinitely waiting until water temperature is supplied. In addition, it may be possible to induce the user to connect water temperature to the laundry washing apparatus 10 by recommending use of water temperature later.

The notification information at the completion time point may include recommendation information for appropriate management when the laundry treating apparatus is left unattended until a next course or option is executed.

The recommendation information may include ventilation information #3 that recommends opening the door to dry or ventilate the inside of the drum.

The notification information at the completion time point may not be an essential condition for operating the laundry treating apparatus. Accordingly, the notification information at the completion time point a4 may be removed from the display portion P8 when confirmation of the user is input or the reference time elapses.

In addition, when a plurality of notification information at the completion time point a4 is generated, a priority of the notification information may be determined, and only a reference number of the notification information may be displayed on the display portion P8.

Accordingly, only notification information required for the user may be provided. For example, the correction information may have a higher priority than the recommendation information to induce the user to correct the habit of the user more rapidly.

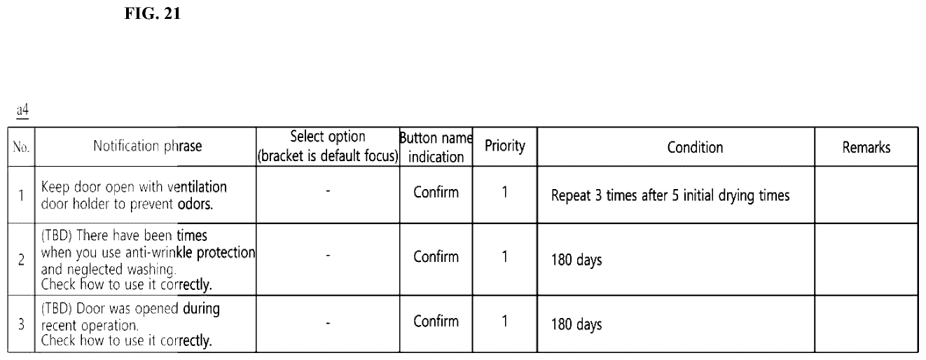

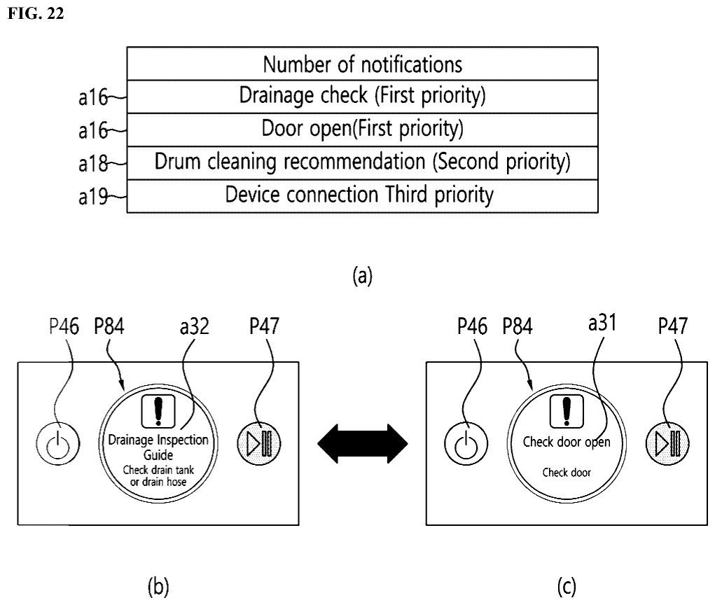

FIG. 21 shows a type and a reference of notification information to be displayed at a completion time point in the laundry dry apparatus 20.

In the laundry dry apparatus 20, the control panel P may generate correction information or recommendation information at the completion time point a4.

For example, when a drying course and option are completed, the recommendation information may include door information #1 that requests the control panel P to arrange the door 112 to be opened. Thus, the user may take out laundry from the laundry dry apparatus 20 and may then accommodate the limiting portion 10b on the locking portion 10c of the cabinet 1 through the door information #1.

The correction information may include induction information #2 for inducing a quick withdrawal habit of the user when laundry remains inside for more than an allowable time after completion of the course or the option.

For example, the drying control panel PA may perform an anti-wrinkle cycle to prevent wrinkling of laundry when the course or the option is completed. The anti-wrinkle cycle may correspond to change in the position of dried laundry by intermittently rotating a drum. The laundry may be prevented from wrinkling by changing an area pressed by a weight of the laundry itself.

When the anti-wrinkle cycle is repeatedly used for a long period of time, the user may determine that laundry is not taken out quickly after drying is completed. Accordingly, through the induction information #2, the user may correct a habit to quickly take out laundry after use of the laundry dry apparatus 20.

The correction information may include safety information #3 may include safety information #3 for requesting correction of a habit to the user when there is a problem with safety, such as the door 112 being opened during execution of the course or the option.

(a)-(c) of FIG. 22 shows an embodiment in which a plurality of notification information is generated and is display on the display portion P8 according to the present disclosure.

The notification information may be generated in plurality according to a situation and a time point. Alternatively, the plurality of the notification information may be generated irrespective of a time point.

In this case, when all the generated notification information is displayed on the display portion P8, the user may have trouble checking all of the notification information.

In addition, as long as the display P84 of the display portion P8 is disposed inside the manipulation portion P4, it may be physically impossible to display all the notification information.

In addition, the plurality of notification information may be displayed whenever the laundry treating apparatus is operated, and thus the user may always delay an operation of the laundry treating apparatus.

Although there is information that the user needs to recognize right now among the plurality of notification information and there is information to be ignored, displaying all of them on the display portion P8 may cause waste.

To prevent this, the laundry treating apparatus according to the present disclosure may set priorities of the plurality of notification information and may display only notification information corresponding to a higher priority, and when the priorities are the same, only notification information corresponding to the reference number may be displayed.

Accordingly, the user may intensively read notification information by checking only the notification information selected as important among the plurality of notification information, and may also eliminate the trouble.

Referring to (a) of FIG. 22, the control panel P may generate a plurality of notification information.

For example, the control panel may generate notification information including tank information a16 to check the state of the water storage 7 because drainage is not performed in the water collecting portion 37, door information a17 indicating that the door is opened while operating, tub washing information a17 to perform washing or sterilization of the drum, and communication information a19 indicating that communication connection with other devices is not possible.

In this case, the control panel P may determine priorities of the plurality of notification information or may check the priorities when the priorities are preset. In addition, the reference number may be set to two.

Referring to (b) of FIG. 22, the control panel P may determine or detect that the tank information a16 and the door information a17 have the first priority, and may determine or detect that the tub washing information a17 and the communication information a19 have a lower priority.

In this case, the tank information a16 and the door information a17 may correspond to the reference number, and the control panel P may control the display portion P8 to display the tank information a16 and the door information a17. In addition, the control panel P may determine or detect that the door is open, as shown in (c) of FIG. 22.

The control panel P may alternately display the tank information a16 and the door information a17.

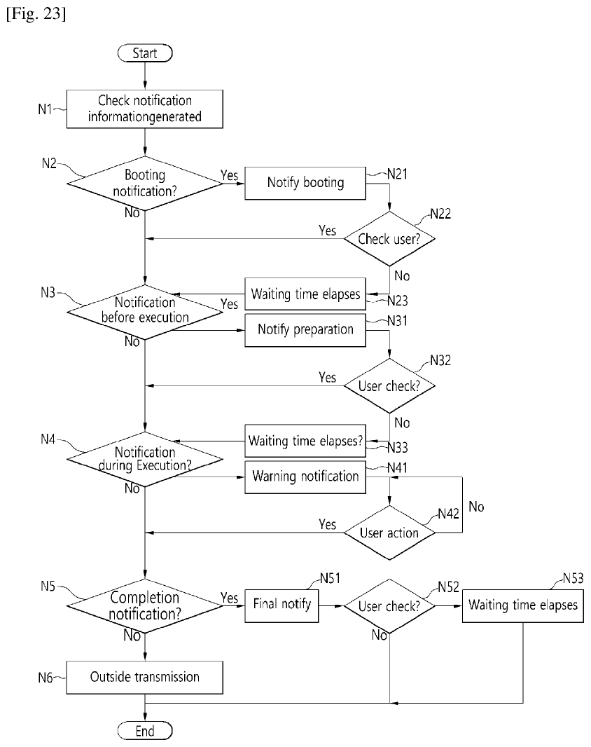

FIG. 23 shows a control method of displaying notification information by a laundry treating apparatus according to the present disclosure.

The control panel P applied to the laundry treating apparatus according to the present disclosure may perform a notification information checking step N1 of generating notification information according to an external signal received from the outside of the cabinet 1 or an internal signal generated by checking the internal state of the cabinet 1 internal state or checking the generated notification information.

The control panel P may perform time point determination steps N2. N3, N4, and N5 of checking a time point at which the notification information needs to be displayed to the user. In the time point determination steps N2, N3, N4, and N5, the time point may be sequentially checked, but the time point at which the notification information is displayed may be determined at once according to the type and characteristics of the notification information. In the time point determination steps N2, N3, N4, and N5, the display time may be determined according to the type and characteristic of the notification information.

The control panel P may check the external signal or the internal state of the cabinet to generate notification information.

The control panel P may classify the notification information into the condition information, the recommendation information, the action information, and the completion information. A reference for classifying the notification information may be predetermined in the storage S.

The storage S may store a usage history of the course or the option. The control panel P may generate the recommendation information based on the usage history.

For example, the course arrangement information may correspond thereto. A course or an option that is frequently used by the user may also correspond to the recommendation information. The external signal may include one or more of weather, humidity, or temperature in an area in which the cabinet is located. The external signal may be transmitted through the server 50 and the external terminal 40.

The control panel P may also generate recommendation information that recommends a course and an option based on the external signal.

The condition information and the recommendation information may be displayed at the booting time point a1 or the selection time point a2, the action information may be displayed at the execution time point a3, and the completion information may be displayed at the completion time point a4.

The control panel P may perform an initial inspection step N2 of inspecting whether the notification information needs to be displayed at the booting time point a1.

In the initial inspection step N2, when the control panel P or the main controller M1 determines that the notification information needs to be displayed at the booting time point, a booting notification step N21 of displaying the notification information on the display portion P8 at the booting time point may be performed. For example, when the notification information is the condition information or the recommendation information, the notification information may be displayed at the booting time point.

In the booting notification step N21, a booting check detection step N22 of inspecting whether the user checks the notification information may be performed. When the user inputs confirmation intention through the selection portion R, the notification information may be removed. When the user does not input the confirmation intention, a booting time determination step N23 of determining whether the reference time elapses may be performed. Even if the booting notification step N21 is performed, when the user does not check the reference time, the booting notification step N21 may be terminated. Thus, delay of the course or the option may be prevented.

The control panel P may perform a mid-term inspection step N3 of inspecting whether the notification information needs to be displayed before the course and the option are executed. In the mid-term inspection step N3, whether the notification information needs to be displayed in the state in which the course and the option are selected may be inspected. For example, when the notification information is the condition information or the recommendation information, the notification information may be displayed at the selection time point a2.

When the notification information is determined to be displayed at the selection time point a2, the display portion P8 may perform a preparation notification step N31 of displaying the notification information at the selection time point.

In the preparation notification step N31, a preparation check detection step N32 of inspecting whether the user checks the notification information may be performed. When the inputs confirmation intention through the selection portion R, the notification information may be removed. When the user does not input the confirmation intention, a preparation time determination step N33 of determining whether the reference time elapses may be performed. Although the preparation notification step N31 is performed, when the user does not check the reference time, the preparation notification step N31 may be terminated. Thus, delay of the course or the option may be prevented.

The control panel P may perform a final inspection step N4 of inspecting whether the notification information needs to be displayed at the execution time point a3 may be performed. That is, whether the notification information needs to be displayed during execution of the course and the option may be inspected.

The action information may be displayed on the execution time point a3.

When the notification information is determined to be displayed at the execution time point a3, the display portion P8 may perform a warning notification step N41 of displaying the notification information at the execution time point a3. In the warning notification step N41, an action detection step N42 of detecting an action of the user may be performed. The action of the user may refer to resolving a cause of generation of the action information. When there is no action by the user, the warning notification step N41 may be performed. When there is no action by the user for a specific time or the user only operates the control panel P, the warning notification step N41 may display an image or a QR code for solving the action on the display portion P8.

The control panel P may perform a completion inspection step N4 of inspecting whether the notification information needs to be displayed at the completion time point a4. The completion information may be determined to be displayed at the completion time point a4.

When the notification information is determined to be displayed at the completion time point a4, the display portion P8 may perform a final notification step N51 of displaying the notification information at the completion time point. Thus, in the laundry treating apparatus according to the present disclosure, whether the notification information is displayed may be determined at a specific time point when the notification information is generated. In the final notification step N51, a final check detection step N52 of inspecting whether the user checks the notification information may be performed. When the user inputs confirmation intention through the selection portion R, the notification information may be removed. When the user does not input the confirmation intention, a final time determination step N53 of determining whether the reference time elapses may be performed. Although the final notification step N51 is performed, when the user does not check the reference time, the final notification step N51 may be terminated. Thus, delay of the course or the option may be prevented.

When the notification information is not information to be displayed at the booting time point a1, the selection time point a2, the execution time point a3, and the completion time point a4, an external transmission step N6 of taking an action of transmitting the information to the server 50 or the external terminal 40 and processing the information may be performed.

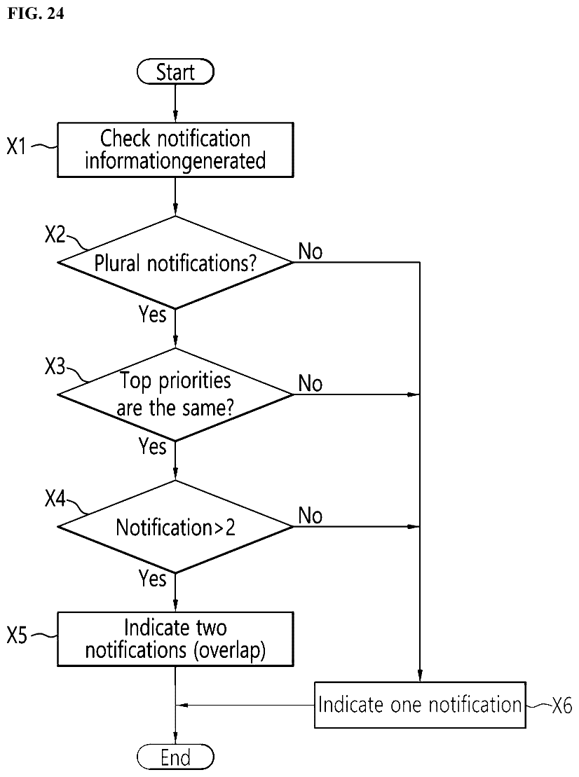

FIG. 24 shows a control method of determining and guiding priorities when there is a plurality of notifications.

The laundry treating apparatus according to the present disclosure may perform a generation checking step X1 of checking that the notification information is generated.

When the notification information is generated, the laundry treating apparatus according to the present disclosure may perform a number determination step X2 of determining whether the generated notification information is plural.

In the number determination step X2, when the notification information is singular, the display portion P8 may display the notification information without change, and when the notification information is plural, the display portion P8 may preferentially display one notification information.

When the notification information is determined to be plural, a priority determination step X3 of determining whether priorities of the notification information are different may be performed.

The controller may determine priorities when the notification information is plural, and may determine that the display portion displays notification information corresponding to a top priority among the plurality of notification information.

When the priorities are the same, a final determination step X4 of determining whether the number of notification information with same priority is equal to or greater than a reference value may be performed.

The reference value may correspond to 2.

In the final determination step, the number is 2 or more, an overlap determination step X5 of displaying two notifications on the display portion P8 may be performed. In the overlap determination step X5, two notifications may be sequentially displayed. When the notification information corresponding to the top priority is still plural, the display portion may sequentially display the notification information. The display portion P8 may first display one notification information among the plurality of notification information, and when a signal of the manipulation portion P4 is input, the display portion P8 may display another notification information.

The display portion P8 may alternately display the plurality of notification information.

In the final determination step, when the number is 3 or more, a single display step X6 of integrating the two or more notification information to generate one notification information and displaying the generated notification information on the display portion P8 may be performed.

Needless to say, when the notification information corresponding to the top priority is 3 or more, the display portion P8 may display two notification information of the three notification information. The display portion P8 may sequentially display the two notification information or may display the notification information in one image.

As a result, the display portion P8 may block display of the 3 or more notification information.

In the number determination step X2, when the number of notification information is one, the single display step X6 may be performed.

When priorities are different in the priority determination step X3, the single display step X6 of displaying notification information corresponding to a top priority may be performed.

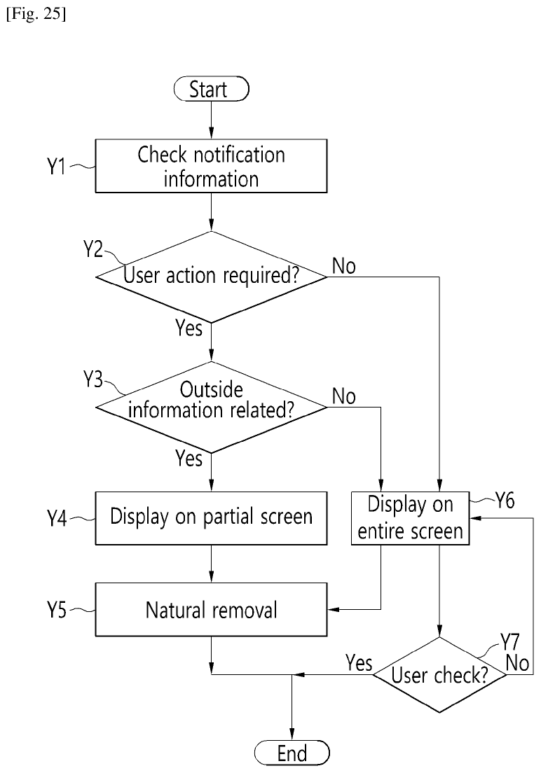

FIG. 25 shows a control method in which a guiding method is changed according to importance of notification.

The laundry treating apparatus according to the present disclosure may perform a notification information checking step Y1 of classifying the notification information into first notification information related to the internal state of the cabinet among the notification information and second notification information related to the external signal when the notification information is generated.

The laundry treating apparatus according to the present disclosure may perform an action required step Y2 of inspecting whether the user needs to take an action in the case of the notification information, and a source determination step Y3 of determining whether the notification information is related to outside information. If the notification information is not related to outside information, the process proceeds to step Y6, in which the notification information may be displayed on the entire portion of the display portion P8. From step Y6, a natural removal step Y5 of removing the notification information can be displayed, and thereafter, the process ends.

When the action of the user is not required and the source is outside information, a partial display step Y4 of displaying the notification information only on a portion of the display P84 of the display portion P8 may be performed. A natural removal step Y5 of removing the notification information displayed in partial display step Y4 after the reference time elapses may be performed.

However, when the user needs to take an action in the case of the notification information, the notification information may be displayed on an entire portion of the display portion P8. Although the user does not need to take an action in the case of the notification information, when the notification information corresponds to inside information, the notification information may be displayed on the entire portion of the display portion P8, in step Y6.

Thereby, when the notification information is displayed on the display portion P8, the user may intuitively determine a weight of the notification information according to a size or a shape of the displayed information. After step Y6, it is determined whether a user performs a check based on the display notification information, in step Y7. If the user performs the check, the process ends, and if the user does not perform the check, step Y6 is repeated until the user performs the check.

In other words, the laundry treating apparatus according to the present disclosure may classify the notification information into first notification information related to an internal state of the cabinet among the notification information and second notification information related to the external signal.

In this case, the laundry treating apparatus according to the present disclosure may display the first notification information as more important than the second notification information.

The display portion P8 may display the first notification information longer or larger than the second notification information.

The display portion P8 may remove display of the second notification information when the reference time elapses. However, the first notification information may be removed only when confirmation of the user is input even when the reference time elapses.

The display portion P8 may display the second notification information on a partial screen or as a pop-up. However, the display portion P8 may display the first notification information on a full screen or may display only the first notification information on the display P84.

The action information may correspond to the first notification information, the condition information may also correspond to the first notification information, and arrangement information for arranging the course or the option without a usage history during a specific number or a specific period among the recommendation information may also correspond to the first notification information.

The recommendation information that recommends ventilation of the drum may also correspond to the first notification information.

As a result, information except for information generated by receiving the external signal may correspond to the first notification information.

The display portion P8 may further include the speaker K1 for generating sound to the outside, and the speaker K1 may generate sound when the first notification information is generated.

The present disclosure may be modified and implemented in various forms, but the scope of the rights is not limited to the above-described embodiments. Therefore, when the modified embodiment includes the elements of the claims of the present disclosure, it needs to be regarded as belonging to the scope of the present disclosure.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

Various embodiments described herein may be implemented in a computer-readable medium using, for example, software, hardware, or some combination thereof. For example, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions may be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-30. (canceled)

31. A laundry treating apparatus comprising:
a cabinet;
a drum provided inside the cabinet, the drum being configured to accommodate laundry therein;
a manipulation portion coupled to the cabinet, the manipulation portion being configured to receive a command for selecting or changing a course or an option for rotating the drum;
a communicator provided inside the cabinet, the communicator being configured to receive an external signal;
a controller configured to inspect the external signal or an internal state of the cabinet to generate notification information; and
a display portion configured to display the notification information to an outside at any one of a booting time point of supplying power to the display portion, a selection time point of the course or the option, an execution time point of executing the course or the option, and a completion time point of completing the course or the option.

32. The laundry treating apparatus of claim 31, wherein the notification information includes condition information indicating that a condition required to execute the course or the option is insufficient, and
wherein the display portion is further configured to display the condition information at the booting time point or the selection time point.

33. The laundry treating apparatus of claim 31, wherein the notification information includes recommendation information for recommending the course or the option to a user, and
wherein the display portion is further configured to display the recommendation information at the booting time point or the selection time point.

34. The laundry treating apparatus of claim 33, wherein the external signal includes one or more of weather, humidity, or temperature in an area in which the cabinet is located, and
wherein the controller is further configured to generate the recommendation information based on the external signal.

35. The laundry treating apparatus of claim 33, wherein the controller includes a storage configured to store a usage history of the course or the option, and wherein the controller is further configured to generate the recommendation information based on the usage history.

36. The laundry treating apparatus of claim 31, wherein the controller includes a storage configured to store a usage history of the course or the option,
wherein the notification information includes arrangement information for preventing a course or an option without a usage history, during a specific period, from being displayed on the display portion, and
wherein the display portion is further configured to display the arrangement information at the booting time point or the selection time point.

37. The laundry treating apparatus of claim 31, wherein the notification information includes action information indicating a state in which the course or the option is not capable of being continued or the course or the option is not capable of being executed, and
wherein the display portion is further configured to display the action information at the execution time point.

38. The laundry treating apparatus of claim 31, wherein the notification information includes recommendation information for recommending ventilation of the drum, and
wherein the display portion is further configured to display the recommendation information at the completion time point.

39. The laundry treating apparatus of claim 38, wherein the notification information further includes correction information for inducing a user to correct a method of using the course or the option, and
wherein the display portion is further configured to display the correction information at the completion time point.

40. A laundry treating apparatus comprising:
a cabinet;
a drum provided inside the cabinet, the drum being configured to accommodate laundry therein;
a manipulation portion coupled to the cabinet, the manipulation portion being configured to receive a command for selecting or changing a course or an option for rotating the drum;
a communicator provided inside the cabinet, the communicator being configured to receive an external signal;
a controller configured to inspect the external signal or an internal state of the cabinet to generate notification information; and
a display portion configured to:
display the notification information to an outside,
in response to the notification information being singular, display the notification information without change, and
in response to the notification information being plural, preferentially display one of the plural notification information.

41. The laundry treating apparatus of claim 40, wherein the controller is further configured to determine priorities in response the notification information being plural, and
wherein the display portion is further configured to display notification information related to a top priority among the plural notification information.

42. The laundry treating apparatus of claim 41, wherein the display portion is further configured to, in response to the notification information related to the top priority being plural, sequentially display the plural notification information.

43. The laundry treating apparatus of claim 42, wherein the plural notification information includes first notification information and second notification information, and
wherein the display portion is further configured to:
display the first notification information, and
display second notification information in response to the command being input.

44. The laundry treating apparatus of claim 42, wherein the display portion alternately is configured to display the plural notification information.

45. The laundry treating apparatus of claim 42, wherein the controller is further configured to, in response to the notification information related to the top priority being plural, integrate the plural notification information into one notification information.

46. The laundry treating apparatus of claim 41, wherein the display portion is further configured to block display of three or more of the notification information.

47. The laundry treating apparatus of claim 46, wherein the display portion is further configured to display two notification information in response to the notification information related to the top priority being three or more.

48. The laundry treating apparatus of claim 47, wherein the display portion is further configured to sequentially display two or more notification information or display the two or more notification information on one screen.

49. The laundry treating apparatus of claim 46, wherein the controller is further configured to transmit the notification information to the outside through the communicator based on the notification information not being displayed on the display portion.

50. A laundry treating apparatus comprising:
a cabinet;
a drum provided inside the cabinet, the drum being configured to accommodate laundry therein;
a manipulation portion coupled to the cabinet, the manipulation portion being configured to receive a command for selecting or changing a course or an option for rotating the drum;
a communicator provided inside the cabinet, the communicator being configured to receive an external signal;
a controller configured to inspect the external signal or an internal state of the cabinet to generate notification information; and
a display portion configured to display the notification information to an outside, wherein the notification information includes first notification information related to an internal state of the cabinet and second notification information related to the external signal.

51. The laundry treating apparatus of claim 50, wherein the display portion is further configured to, in response to a reference time elapsing, remove display of the second notification information.

52. The laundry treating apparatus of claim 50, wherein the display portion is further configured to display the second notification information on a partial screen or as a pop-up.

53. The laundry treating apparatus of claim 50, wherein the display portion is further configured to display the first notification information on an entire screen or display only the first notification information.

54. The laundry treating apparatus of claim 53, wherein the display portion is further configured to display the first notification information until the command is input.

55. The laundry treating apparatus of claim 54, wherein the first notification information includes action information indicating a state in which the course or the option is not capable of being continued or the course or the option is not capable of being executed, and
wherein the display portion is further configured to display the action information until the command is input.

56. The laundry treating apparatus of claim 53, wherein the first notification information includes condition information indicating that a condition required to execute the course or the option is insufficient, and
wherein the display portion is further configured to remove display of the condition information in response to a specific time elapsing.

57. The laundry treating apparatus of claim 53, wherein the first notification information includes recommendation information for recommending the course or the option to a user, and
wherein the display portion is further configured to remove display of the recommendation information in response to a specific time elapsing.

58. The laundry treating apparatus of claim 53, wherein the controller includes a storage configured to store a usage history of the course or the option,
wherein the first notification information includes arrangement information for preventing the course or the option without a usage history during a specific period from being displayed on the display portion, and
wherein the display portion is further configured to, based on a specific time elapsing, remove display of the arrangement information.

59. The laundry treating apparatus of claim 53, wherein the first notification information includes recommendation information for recommending ventilation of the drum, and
wherein the display portion is further configured to, in response to a specific time elapsing, remove display of the recommendation information.

60. The laundry treating apparatus of claim 50, wherein the display portion further includes a speaker for generating sound to an outside, and
wherein the speaker is configured to generate sound in response to the first notification information being generated.
